(19) United States
(12) Patent Application Publication
(10) Pub. No.: US 2004/0159605 A1
(43) Pub. Date: Aug. 19, 2004

(54) Compositions of insoluble magnesium containing minerals for use in fluid filtration

(76) Inventor: Kenneth D. Hughes, Alpharetta, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/467,679

(22) PCT Filed: Feb. 1, 2002
(86) PCT No.: PCT/US02/02914

(51) Int. Cl. B01D 39/02

(52) U.S. Cl. 210/503; 210/505; 210/508; 55/527

(57) ABSTRACT

A method and device for the filtration and/or purification of fluids water or other solutions containing microbiological and chemical contaminants, such as fluids containing cysts, bacteria and/or viruses, and heavy metals and/or pesticides, where the fluid is passed through a purification material composed of magnesium containing mineral and more preferably silicates containing magnesium, oxides containing magnesium, hydroxides containing magnesium, and phosphates containing magnesium and absorption media in a fixed binder matrix.

### FIELD OF THE INVENTION

This invention relates generally to the field of solution and fluid filters c purification devices, primarily to aqueous solution filters and water purification, devices for gases and water and other aqueous liquids, which remove contaminants from the gas or aqueous liquid solution passed through them. In its more particular aspects, the invention relates to the field of such devices that remove chemical and microbiological contaminants, including heavy metals and pesticides, bacteria and viruses and their components, from water or aqueous solutions.

### BACKGROUND OF THE INVENTION

Purification or filtration of water or other aqueous solutions is necessary for many applications, from the provision of safe or potable drinking water to biotechnology applications including fermentation processing and separation of components from biological fluids. Similarly, the removal of microbial organisms from breathable air in hospitals and clean rooms, where ultrapurified air is required, and in environments where the air will be recirculated, such as aircraft or spacecraft, is also an important application for filtration media. In recent years, the need for air filtration and purification in the home has become more recognized, and the competing concerns of energy efficiency and indoor air quality have lead to numerous air filtration products, such as HEPA filters and the like, that purport to remove small particles, allergens, and even microorganisms from the air.

There are many well-known methods currently used for water purification, such as distillation, ion-exchange, chemical adsorption, filtering or retention, which is the physical occlusion of particulates. Particle filtration may be completed through the use of membranes or layers of granular materials, however in each case the pore size of the material and the space between the granular materials controls the particle size retained. Additional purification media include materials that undergo chemical reactions, which alter the state or identity of chemical species in the fluid to be purified.

In most cases a combination of techniques are required in order to completely purify fluids, such as water. Combinations of technologies may be implemented by combining functions in a single device or using several devices in series where each performs a distinct function. Examples of this practice include the use of mixed resins that remove both negative and positively charged chemical species as well as species without charge.

Many of these water purification techniques and practices are costly, energy inefficient and/or require significant technical know-how and sophistication. Traditional means of reducing these complications require extensive processing or specially designed apparatus. Unfortunately, development of low cost techniques do not adequately address the removal of harmful chemical and biological contaminates, bacteria and viruses. For example, simple point-of-use purification devices, such as filters attached to in-house water supply conduits or portable units for campers and hikers, cannot sufficiently remove bacteria and viruses unless relatively costly membrane technology or strong chemical oxidizers, such as halogens or reactive oxygen species, are utilized.

The Environmental Protection Agency (EPA) has set forth minimum standards for acceptance of a device proposed for use as a microbiological water purifier. Common coliforms, represented by the bacteria E. coli and Klebsiella terrigena, must show a minimum 6-log reduction, 99.9999% of organisms removed, from an influent concentration of 1×10⁷/100 ml. Common viruses, represented by poliovirus 1 (LSc) and rotavirus (Wa or SA-11), which show resistance to many treatment processes, must show a minimum 4 log reduction, 99.99% of organisms removed, from an influent concentration of 1×10⁷/L. Cysts, such as those represented by Giardia muris or Giardia lamblia, are widespread, disease-inducing, and resistant to chemical disinfection. Devices that claim cyst removal must show a minimum 3 log reduction, 99.9% of cysts removed, from an influent concentration of 1×10⁶/L or 1×10⁷/L, respectively. The EPA has accepted the use of other particles in the appropriate size range as a means of testing devices that claim this function.

Materials that are highly efficient at removing and immobilizing microbial organisms have numerous applications, but a particular area of application is in the biotechnology and fermentation industries. Not only would such materials be useful in the processing of fermentation broth for recycling or reuse, they also would have utility as microbial immobilization materials for the microbes of interest to the fermentation process.

It is known to use magnesium silicates, magnesium oxides, magnesium hydroxides and magnesium phosphates in granular or particulate, or in fiber form as a chemical binding agent.

Some forms of magnesium silicates are known as asbestos and these materials which can be mined in fiber form have been mixed with cellulose and used for the removal of microorganisms and particulate matter from fluids that will be used for consumption. The application of magnesium silicates in the form of asbestos containing minerals for fluid filtration has decreased dramatically since the materials are known to cause respiratory diseases when inhaled. Magnesium silicates in the form of asbestos fibers have found commercial application as fire retardant materials and materials capable of strengthening concretes and synthetic polymers.

Non asbestos forms of magnesium silicates include minerals identified as talc(s) and are used commercially in the pharmaceutical and cosmetic, and paint and coating industries. Aluminum and magnesium containing silicates are also used in these fields.

Magnesium containing silicates can be produced through chemical synthesis or obtained through mining/processing of raw ores, which are found globally. Magnesium containing silicates, magnesium oxides, magnesium hydroxides and magnesium phosphates can function as a biological water purification agent through a complex process, which includes the chemical adsorption of chemicals, biological materials and microorganisms.

Magnesium silicates are naturally occurring minerals that are commonly found in a mixture of structural forms and with varying concentrations of other metals substituted for the magnesium metal. Magnesium oxides, magnesium hydroxides and phosphates can also be found naturally and produced by synthetic methods.

Other components of the mined mixtures of magnesium silicates include metals such as aluminum, titanium, calcium, iron, copper, and many others. Magnesium oxides are generated for use in many products but include water treatment processes. Magnesium phosphates can be used in a range of applications including water treatment.

There are no known commercially available microbiological filtration or purification devices incorporating magnesium silicate, magnesium oxide, magnesium hydroxide, or magnesium phosphate compounds in porous block form. There is literature indicating that magnesium silicates may be used as filtration materials, especially in fiber form and even more specifically when mixed with cellulose and/or fiberglass fibers. The use of magnesium silicates, specifically asbestos fiber filter sheets, to treat water is discussed in the literature and previously demonstrated by companies like Seitz. Seitz produced asbestos fiber filters for treating water for the beverage industry for many years. There is no known disclosure of using magnesium silicates in block form to remove microbial organisms from the water treatment stream.

However, it has not been demonstrated that magnesium silicates may be used or incorporated in a device that meets the minimum EPA requirements described above. In addition there have been no efforts to generate porous block materials that eliminate the hazards associated with the use of some types of magnesium silicate materials.

Scientific literature indicates that cellulose-asbestos filter sheets were also examined for incorporation into rapid concentration laboratory methods for virus analysis, but these efforts proved unsuccessful.

A water treatment process is also disclosed in U.S. Pat. No. 4,167,479, which uses an active media made of powdered minerals (less than 50 mesh) and active micro-organisms to purify waste water. The active media is combined with the wastewater and circulated to allow biological and chemical reactions to occur. The minerals in this process are used as granular additives to the water system and are dispersed throughout the fluid, as opposed to being part of a binder material through which the water to be treated would flow. This reference does not provide or suggest a method for removing microorganisms from the wastewater. In fact, it actually uses active microorganisms as part of the treatment, and does not contemplate their removal. Furthermore, the reference specifically emphasizes that the minerals provide metal ions to precipitate phosphates, reducing or eliminating the need to use other types of chemicals, such as alum, for precipitating phosphates.

Additionally, materials in the fields of ceramic and bio-implants are known. These materials, however, are not fabricated for, nor are they capable of passing fluids for the purpose of fluid filtration.

Accordingly, there remains a need in this art for an uncomplicated, safe, inexpensive fluid purification and filtration method and device incorporating magnesium silicates, magnesium oxides, magnesium-aluminum silicates, magnesium hydroxides, and magnesium phosphates obtained from natural and synthetic materials. It is the intention of this invention and art to use magnesium containing minerals to generate a practical fluid purification and a filtration device and method that permits the safe use of all magnesium silicates, oxides, and phosphates in the forms which are readily available and commonly found or synthesized by a variety of different methods. There is also a need in the art for a method and device that meets the minimum EPA requirements for designation as a microbiological water purifier, such that the device is more than suitable for consumer and industry point-of-use applications.

### SUMMARY OF THE INVBNTION

To this end, the present inventors have discovered that a significant problem in the known use of some types of magnesium silicate containing filter devices is that the mineral material is dangerous when inhaled and when used as filter sheets open to the atmosphere, fibers of the mineral can be lost and possibly inhaled. These sheets also can be ripped or torn and present a hazard.

Further, the present inventors have discovered that an additional significant problem in the known magnesium containing minerals incorporating filter devices is that when the magnesium containing minerals are in loose form, whether granular, particulate, or fiber. The effectiveness of filters generated with materials in loose form is compromised by channeling and by-pass effects caused by the pressure of fluid, in particular, water and aqueous solutions, flowing through the filter media as well as particle erosion and aggregation. Because chemicals, viruses and bacteria are removed by intimate contact with the adsorption material, even relatively small channels or pathways in the granular material formed over time by water pressure, water flow, particle erosion, or particle aggregation are easily sufficient to allow passage of undesirable microbiological contaminants through the filter.

For example, taking water as an exemplary fluid and using the material of the invention as a filtration medium for microbial organisms, calculations based on a virus influent concentration of 1×10⁶/L show that where a 4-log reduction is to be expected, only a 3.7 log reduction actually occurs if only 0.01% of the water bypasses treatment by passing through channels formed in the filter media during filtration. If 0.1% of the water passes through untreated, then only a 3 log reduction occurs. If 1% passes through untreated, only a 2 log reduction occurs, and if 10% passes untreated, only a 1 log reduction occurs. Where a 6-log reduction is expected, the detrimental results of channeling are even more dramatic, with only a 4-log reduction actually occurring when 0.01% of the water bypasses treatment. This invention solves this problem by providing a microbiological filter and method for removing contaminants, including bacteria and viruses, where magnesium containing minerals and other granular adsorptive filter media are fixed within a chemical binder material to form a porous filter material that eliminates the possibility of channeling and active agent by-pass.

This invention is in general a device and method for the purification and filtration of aqueous fluids, in particular water (such as drinking water or swimming or bathing water), or other aqueous solutions (such as fermentation broths and solutions used in cell culture), or gases and mixtures of gases such as breathable air, found in clean rooms, hospitals, diving equipment homes, aircraft, or spacecraft, and gases used to sparge, purge, or remove particulate matter from surfaces. The use of the device and method of the invention results in the removal of an extremely high percentage of microbiological contaminants, including bacteria and viruses and components thereof. In particular, the use of the device and method of the invention results in purification of water to a level that meets the EPA standards for designation as a microbiological water purifier. In one embodiment, the invention relates to a purification material for fluids that contains particulate magnesium containing minerals that is in the form of a porous block as the result of the presence of a binder. Typically, at least a portion of these magnesium containing minerals is from magnesium silicates, magnesium aluminum silicates, magnesium oxides, magnesium phosphates and/or related magnesium containing minerals, and has been obtained from natural sources, e.g., mining, or from synthetic sources such as the mixing of chemicals containing silicon, magnesium, and aluminum. Also typically, the binder is a polymeric or oligomeric material that is capable of maintaining the particulate magnesium mineral in a block structure. This allows the purification material to be molded or pressed into any desired shape, e.g., a shape suitable for inclusion into the housing of a filtration device, which provides for fluid inflow and outflow, and which filtration device has one or more chambers for contact of the fluid with the purification material. Such a device forms another embodiment of the invention. In addition to maintaining the magnesium mineral particles immobilized in a unitary block, the-polymeric binder also provides desirable physical characteristics to the filter material, e.g., rendering it rigid or flexible, depending upon the type and amount of polymeric binder used.

In another embodiment, the invention relates to a purification material for fluids that is in the form of a sheet or membrane, containing the particulate magnesium containing minerals and immobilized with a binder.

In another embodiment, the invention relates to a purification material for fluids that is in the form of a block, sheet or membrane, containing the particulate magnesium containing minerals and immobilized with a pressure-technique that uses fluid-swelling materials.

The invention also relates to methods of filtering fluids, such as water, aqueous solutions, and gases, to remove a large proportion of one or more types of microorganisms contained therein, by contacting the fluid with the purification material of the invention. In a particular aspect of this embodiment of the invention, this contacting occurs within the device described above, with the unfiltered fluid flowing through an inlet, contacting the purification material in one or more chambers, and the filtered fluid flowing out of the chamber through an outlet.

The purification material of the invention can be used to purify drinking water, to purify water used for recreational purposes, such as in swimming pools, hot tubs, and spas, to purify process water, e.g. water used in cooling towers, to purify aqueous solutions, including but not limited to, fermentation broths and cell culture solutions (e.g., for solution recycling in fermentation or other cell culture processes) and aqueous fluids used in surgical procedures for recycle or reuse, and to purify gases and mixtures of gases such as breathable air, for example, air used to ventilate hospital or industrial clean rooms, air used in diving equipment, or air that is recycled, e.g., in airplanes or spacecraft, and gases used to sparge, purge or remove volatile or particulate matter from surfaces, containers, or vessels. The purification material of the invention has the additional advantage of making use of readily available magnesium mineral materials, including those obtained from natural sources, while still maintaining high purification efficiency.

In yet another embodiment of the invention, the material of the invention, namely magnesium containing minerals and optionally other adsorptive materials in a binder matrix and formed into a block or sheet, can be used as an immobilization medium for microorganisms used in biotechnology applications such as fermentation processes and cell culture. In this embodiment, biological process fluids, such as nutrient, broths, substrate solutions, and the like, are passed through the immobilization material of the invention in a manner that allows the fluids to come into contact with the microorganisms immobilized therein, and effluent removed from the material and further processed as needed.

### BRIEF DESCRIPTON OF THE DRAWINGS

FIG. 1 is a cross-sectional view illustrating a particular embodiment of the invention, namely a water filter housing containing a block filter incorporating magnesium containing minerals and granulated activated charcoal (GAC) in a binder matrix according to the invention.

FIGS. 2a and 2b are schematic views of a particular embodiment of the invention, namely a filter material containing magnesium containing minerals and a binder matrix in the form of a membrane or sheet.

### DETAILED DESCRIPTION OF THE INVENTION

As indicated above, one embodiment of the invention relates to a purification material in the form of a block filter containing granulated magnesium containing minerals in a binder, which is typically a polymeric material. In a particular aspect of this embodiment, the invention relates to a rigid block filter that contains a mixture of granulated magnesium minerals and magnesium-aluminum derivatives and granulated activated charcoal (GAC) or bone char or other adsorptive filter media in a binder material, such as a thermoplastic material, such that the magnesium containing minerals and derivatives and GAC are fixed within the binder matrix, and that channeling from flow during water treatment cannot occur. The purification material of the invention can be produced by extrusion, molding including injection molding, or by compression methods. Fibrillation may also be used to prepare fibrils of the mixture of binder polymer and magnesium minerals that can then be formed-into a sheet, film, or block. It may be produced in any shape or size and may be rigid or flexible. Pressure techniques which use fluid swelling materials may also be used to prepare the mixture of binder and magnesium minerals that can then be formed into a sheet, film, or block. It may be produced in any shape or size and may be rigid or flexible.

The pore size of the filter block influences flow rates of the fluid through the filter, and is a function of the size of the granular particles incorporated into the filter block. As used herein, the term “block” does not denote any particular geometrical shape, but rather that the material is not a sheet or membrane. Nonlimiting examples of “blocks” as this term is intended to be used include tubes, annular rings, as well as more conventional geometrical solids. Material formed into flexible blocks is particularly suitable for use in pipes or tubes that serve as the fluid filter medium.

One of the desirable features of the purification material of the invention is that it may be formed into any desired shape, and thus provides ease of handling and use. For example, the purification material may be formed into a monolith or block that fits into conventional housings for filtration media or it can be shaped to provide purification as part of a portable or personal filtration system. Alternatively, the material may be formed into several different pieces, through which water flows in series or in parallel. Sheets or membranes of the purification material may also be formed. The rigidity of the purification material, whether in block form or in sheet/membrane form, may be altered through inclusion of flexible polymers in the binder material.

While not wishing to be bound by any theory, it is believed that the purification material of the invention achieves its unusually high efficiency in removing microorganisms from fluids partly as the result of the immobilization of the magnesium mineral particles in the binder, and the necessity for fluid flowing through the purification material to follow an extended and tortuous path therethrough, instead of forming channels through the purification material as occurs in prior magnesium mineral-containing purification materials. This path ensures that the fluid contacts a larger proportion of the surface area of the magnesium mineral particles, and it prevents sustained laminar flow of the fluid through the filtration material. This latter effect is believed to help prevent laminae of fluid containing microorganisms from avoiding sustained contact with magnesium-mineral particles in the filter. After the purification material has been in service for a period of time, additional filtration by occlusion will occur as adsorbed material accumulates in the pores of the purification material.

Those familiar with the art of fluid filtration will understand that the pore size and physical dimensions of the purification material may be manipulated for different applications and that variations in these variables will alter flow rates, back-pressure, and the level of chemical and microbiological contaminant removal. Likewise those knowledgeable in the art will recognize that variations in the percentages of each component of the purification material will provide some variability in utility. For example, increasing the percentage of magnesium containing minerals in the purification material will result in a material having an increased number of interaction sites for chemical and biological species, while increasing the percentage of binder will result in a purification material having material and mechanical properties closer to that of the binder material and with reduced interaction sites.

In one particular embodiment of the invention, the magnesium mineral used is in the form of magnesium silicate, and the GAC material are present in approximately equal amounts, with the percentage of binder material kept to a minimum. However, the magnesium mineral used in the invention may be obtained from other natural or synthetic/industrial sources and mixtures of the different derivatives can provide differences in the properties of the purification material. For example, adding sodium to the filter block can increase the sodium concentration in the effluent water if water is used as the fluid. This can be useful in, e.g. purifying hard water in such a way as to maintain desirable water hardness levels therein. Sodium in the filter material may be obtained either by inclusion of sodium containing magnesium minerals, inclusion of sodium salts and compounds, or by pre-conditioning the purification material by passing sodium-containing solutions therethrough.

Likewise, as the number of binding sites is increased through the use of different structural forms and orientation of different crystal faces, the binding of metal ions, radioactive isotopes, and microorganisms can also be increased. Commonly, exposure to increased temperatures allows conversion between crystalline and amorphous forms. Commonly, exposure to metals in a synthesis procedure allows replacement of some of the magnesium ions in both crystalline and amorphous forms.

Those experienced in the art will also understand that many different structural forms including different crystal or amorphous lattices are possible for magnesium minerals, magnesium-aluminum minerals, and for other adsorbent materials used in the invention, and that these variations will yield differences in properties of the resulting purification material, as certain structural structures improve and inhibit interactions with chemicals, microorganisms and other biological materials. These differences in properties result from differences in interactions between the microorganisms and other biological materials and the different positive and negative ions that are included in the crystal structure.

Those experienced in the art will also understand that different chemical and biological reactions can occur when these materials are place in fluids such as water which will change the composition. As example the interaction of magnesium oxide with water and salts can produce magnesium hydroxide.

In another embodiment of the invention, the purification material is constructed to withstand sterilization. Sterilization processes include thermal processes, such as steam sterilization or other processes wherein the purification material is exposed to elevated temperatures or pressures or both, resistive heating, radiation sterilization wherein the purification material is exposed to elevated radiation levels, including processes using ultraviolet, infrared, microwave, and ionizing radiation, and chemical sterilization, wherein the purification material is exposed to elevated levels of oxidants or reductants or other chemical species, and which is performed with chemicals such as halogens, reactive oxygen species, formaldehyde, surfactants, metals and gases such as ethylene oxide, methyl bromide, beta-propiolactone, and propylene oxide.

Additionally, sterilization may be accomplished with electrochemical methods by direct oxidation or reduction with microbiological components or indirectly through the electrochemical generation of oxidative or reductive chemical species. Combinations of these processes are also used on a routine basis. It should also be understood that sterilization processes may be used on a continuous or sporadic basis while the purification material is in use.

In general, the invention comprises a device and a method for the filtration and purification of a fluid, in particular an aqueous solution or water, to remove organic and inorganic elements and compounds present in the water as particulate material. In particular, the device and method can be used to remove chemical and microbiological contaminants, including bacteria and viruses and components thereof, from water or other fluids or gasses destined for consumption or other use by humans or other animals. The method and device of the invention are particularly useful in these applications where the reduction in concentration of microbiological contaminants made possible by the invention meets the EPA standards for microbiological water purification devices, and also exceeds the effectiveness of other known filtration and purification devices incorporating granulated adsorption media that contain magnesium minerals, such as those obtained from magnesium silicate and magnesium-aluminum silicates. In a particular embodiment of the invention, the purification material is a porous block formed by granulated or particulate magnesium minerals, which is defined herein to include magnesium silicates, magnesium aluminum silicates, magnesium oxides, and magnesium phosphates and other optional adsorptive granular materials, described in more detail below, such as granulated activated charcoal (GAC), retained within a polymer binder matrix. In the method corresponding to this particular embodiment, the chemical and microbiological contaminants are removed from the water when the water is forced through the porous block by water pressure on the influent side, or by a vacuum on the effluent side, of the filter block.

In an embodiment of the invention where the purification material is composed of a mixture of magnesium minerals and an adsorptive granular filter media, for example GAC, such components can be dispersed in a random manner throughout the block. The purification material can also be formed with spatially distinct gradients or separated layers. For example, magnesium minerals and GAC granules may be immobilized in separate layers using a solid binder matrix, for instance, a polymer thermoplastic such as polyethylene or the like, so that movement of the magnesium minerals and GAC particles is precluded and detrimental channeling effects during fluid transport through the block are prevented. If the components reside in separate locations, the fluid flow is sequential through these locations. In a particular example of this embodiment, at least a portion of the magnesium minerals present originates from magnesium silicates, magnesium aluminum silicates, magnesium oxides, magnesium phosphates and mixtures thereof. Examples of suitable materials are those designated as magnesium silicates and sold by R.T. Vanderbilt Company and as magnesium oxides and magnesium hydroxide which is sold by Martin Marietta Specialty Chemical. The material may be ground to a desirable particle size, e.g., 80-325 mesh or smaller. A typical analysis of these materials shows 50% or greater and 99% or greater magnesium silicate, magnesium oxide and magnesium hydroxide respectively. The element binding characteristics of these materials have been reported by producers of these raw materials. The organic molecule binding capabilities have also been reported by producers of these raw materials.

In this embodiment, the magnesium containing minerals (magnesium silicates, magnesium aluminum silicates, magnesium oxides, magnesium hydroxides, and magnesium phosphates, etc.) and the GAC are mixed in approximately equal amounts with the minimal amount of binder material necessary to compose a monolithic purification material. However, the concentrations of magnesium minerals, GAC, and binder are substantially variable, and materials having different concentrations of these materials may be utilized in a similar fashion without the need for any undue experimentation by those of skill in the art. In general, however, when GAC, or bone char (apatite containing) is used as the additional adsorbent material, its concentration in the mixture is generally less than 50% by weight, based upon the weight of the composition before any drying or compacting. Additionally, adsorbents other than GAC may be substituted completely for, or mixed with, the GAC in a multicomponent mixture. Examples of these adsorbents include various ion-binding materials, such as synthetic ion exchange resins, zeolites (synthetic or naturally occurring), diatomaceous earth, bone char and apatite minerals, calcium silicate materials and one or more other phosphate-containing materials, such as minerals of the phosphate class, in particular, minerals containing magnesium and silicate described herein.

In particular, minerals of the silicate class, and containing magnesium, are particularly suitable for the invention. These materials may also contain iron, aluminum, and calcium. These materials may be calcined and processed by a number of methods to yield mixtures of varying compositions.

Minerals containing magnesium are found in the hydroxide and oxide class and include magnesium oxides and hydroxides. Magnesium oxide is known as periclase and is industrially important. Brucite is an important mineral containing magnesium which is found associated with many magnesium containing minerals such as those in the serpentine group. The serpentine group includes antigorite, clinochrysotile, lizardite, orthochrysotile, and parachrysotile. Talc is similar to brucite in that it is found associated with many different minerals. It is a common form of magnesium silicate and particularly suitable for the invention.

Minerals containing phosphate and magnesium are particularly suitable for the invention. These minerals are commonly associated with other elements such as calcium, iron, and aluminum and belong to the apatite and phosphate class of minerals.

Minerals containing silicate and magnesium are many and yield particulate matter that is particularly suitable for the invention. As example, the general formula for mica is AB₂₋₃ (Al, Si)Si₃ O₁₀ (F, OH)₂. In most micas the A is usually potassium, K, but can be calcium, Ca, or sodium, Na, or barium, Ba, or some other elements in the rarer micas. The B in most micas can be aluminum, Al, and/or lithium, Li, and/or iron, Fe, and/or magnesium, Mg. The mica group has many members. Examples of common mica minerals include, but are not limited to, Biotite, Fuchsite, Lepidolite, Muscovite, Phlogopite, and Zinnwaldite.

Garnets are also examples of minerals that can be used with this invention. The general formula for garnets is A₃B₂(SiO₄)₃. The A represents divalent metals such as calcium, iron, magnesium and manganese. The B represents a trivalent metal such as aluminum, chromium, iron, and other elements found in rarer members of the group. The garnet is a large group of which examples include, but are not limited to, alnandine, andradite, grossular, pyrope, spessartine, and uvarovite.

The montmorillonite/smectite group is composed of several minerals including pyrophyllite, talc, vermiculite, sauconite, saponite, nontronite and montmorillonite differing mostly in chemical content. The general formula is (Ca, Na, H)(Al, Mg, Fe, Zn)₂(Si, Al)₄O₁₀(OH)₂-xH₂O, where x represents the variable amount of water that members of this group could contain.

The chlorite group is a large and common group of minerals and can be used in the present invention. The general formula is X₄-₆Y₄O₁₀(OH, O)₈. The X represents either aluminum, iron, lithium, magnesium, manganese, nickel, zinc or rarely chromium. The Y represents either aluminum, silicon, boron or iron but mostly aluminum and silicon. Examples include, but are not limited to, Amesite (Mg, Fe)₄Al₄Si₂O₁₀(OH)₈, Baileychlore (Zn, Fe⁺², Al, Mg)₆(Al, Si)₄O₁₀(O, OH)₈, Chamosite (Fe, Mg)₃Fe₃AlSi₃O₁₀(OH)₈, Clinochlore (kaemmererite) (Fe, Mg)₃Fe₃AlSi₃O₁₀(OH)₈, Cookeite LiAl₅Si₃O₁₀(OH)₈, Corundophilite (Mg, Fe, Al)₆(Al, Si)₄O₁₀(OH)₈, Daphnite (Fe, Mg)₃(Fe, Al)₃(Al, Si)₄O₁₀(OH)₈, Delessite (Mg, Fe⁺², Fe⁺³, Al)₆(Al, Si)₄O₁₀(O, OH)₈, Gonyerite (Mn, Mg)₅(Fe+³)₂Si₃O₁₀(OH)₈, Nimite (Ni, Mg, Fe, Al)₆AlSi₃O₁(OH)₈, Odinite (Al, Fe⁺², Fe⁺³, Mg)₅(Al, Si)₄O₁₀(O, OH)₈, Orthochamosite (Fe⁺², Mg, Fe⁺³)₅Al₂Si₃O₁₀(O, OH)₈, Penninite (Mg, Fe, Al)₆(Al, Si)₄O₁₀(OH)₈, Pannantite (Mn, Al)₆(Al, Si)₄O₁₀(OH)₈, Rhipidolite (prochlore) (Mg, Fe, Al)₆(Al, Si)₄O₁₀(OH)₈, Sudoite (Mg, Fe, Al)₄-₅(Al, Si)₄O₁₀(OH)₈, Thuringite (Fe⁺², Fe⁺³, Mg)₆(Al, Si)₄O₁₀(O, OH)₈.

Additional exemplary minerals include the following: Periclase MgO; IMA98.065 Mg₉[Si₄O₁₆](OH)₂; Brucite Mg(OH)₂; Sellaite MgF₂; Kotoite Mg₃B₂O₆; Norbergite Mg₃(SiO₄)(F,OH)₂; Forsterite Mg2SiO4; Ringwoodite Mg2SiO4; IMA96.034 Mg7(PO4)2(OH)8; Suanite Mg2B2O5; Wightmanite Mg5(BO3)O(OH)5.2(H2O); Pokrovskite Mg2(CO3)(OH)2.0.5(H2O); Fluoborite Mg3(BO3)(F,OH)3; Holtedahlite Mg12(PO3OH,CO3)(PO4)5(OH,O)6; Titanclinohumite Mg8Ti(SiO4)4O2; Althausite Mg2(PO4)(OH,F,O); Szaibelyite MgBO2(OH); Magnesite MgCO3; Coalingite Mg10Fe+++2(CO3)(OH)24.2(H2O); Farringtonite Mg3(PO4)2; Nepskoeite Mg4Cl(OH)7.6(H2O); Chrysotile Mg3Si2O5(OH)4; Clinochrysotile Mg3Si2O5(OH)4; Lizardite Mg3Si2O5(OH)4; Orthochrysotile Mg3Si2O5(OH)4; Parachrysotile Mg3Si2O5(OH)4; Brugnatellite Mg6Fe+++(CO3)(OH)13.4(H2O); Shabynite Mg5(BO3)Cl2(OH)5.4(H2O); Hydromagnesite Mg5(CO3)4(OH)2.4(H2O); Chloromagnesite*MgCl2; Olivine*(Mg,Fe)2SiO4; Meixnerite Mg6Al2(OH)18.4(H2O); Dypingite Mg5(CO3)4(OH)2.5(H2O); Giorgiosite Mg5(CO3)4(OH)2.5(H2O); Kovdorskite Mg5(PO4)2(CO3)(OH)2.4.5(H2O); Wagnerite (Mg,Fe++)2(PO4)F; Ludwigite Mg2Fe+++BO5; Artinite Mg2(CO3)(OH)2.3(H2O); Iowaite Mg4Fe+++(OH)8OCl.2-4(H2O); Clinoenstatite Mg2Si2O6; Enstatite Mg2Si2O6 Hydrotalcite Mg6Al2(CO3)(OH)16.4(H2O); Manasseite Mg6Al2(CO3)(OH)16.4(H2O) Chondrodite (Mg,Fe++)5(SiO4)2(F,OH)2; Humite (Mg,Fe++)7(SiO4)3(F,OH)2; Clinohumite (Mg,Fe++)9(SiO4)4(F,OH)2; Magnesiohulsite (Mg,Fe++)2(Mg,Fe+++,Sn++++)O2(BO3); Korshunovskite Mg2Cl(OH)3.3.5-4(H2O); Neighborite NaMgF3; Wadsleyite (Mg,Fe++)2SiO4; Heneuite CaMg5(PO4)3(CO3)(OH); Caminite Mg7(SO4)5(OH)4.(H2O); Phosphoellenbergerite Mg14(PO4)6(PO3OH,CO3)2(OH)6; Colerainite*4MgO.Al2O3.2SiO2.5(H2O); Chlorartinite Mg2(CO3)Cl(OH).3(H2O); Sjogrenite Mg6Fe++2(CO3)(OH)14.5(H2O); Barbertonite Mg6Cr2(CO3)(OH)16.4(H2O); Stichtite Mg6Cr2(CO3)(OH)16.4(H2O); Desautelsite Mg6Mn+++2(CO3)(OH)16.4(H2O); Pyroaurite Mg6Fe+++2(CO3)(OH)16.4(H2O); Anthophyllite [ ]Mg7Si8O22(OH)2; Cummingtonite Mg7Si8O22(OH)2; Muskoxite Mg7Fe+++4O13.10(H2O); Sapphirine (Mg,Al)8(Al,Si)6O20; Nanlingite CaMg4(AsO3)2F4; Niningerite (Mg,Fe++,Mn)S; Sodicanthophyllite NaMg7Si8O22(OH)2; Huntite CaMg3(CO3)4; Sergeevite Ca2Mg11(CO3)9(HCO3)4(OH)4.6(H2O); Dozyite (Mg7Al2)(Si4Al2)O15(OH)12 Geikielite MgTiO3; Barringtonite MgCO3.2(H2O); Sulfoborite Mg3B2(SO4)(OH)8(OH,F)2; Quintinite-2H Mg4Al2 (OH)12CO3.4(H2O); Quintinite-3T Mg4Al2(OH)12CO3.4(H2O); Talc Mg3Si4O10(OH)2; Pinakiolite Mg2Mn+++O2(BO3); Takeuchiite Mg2Mn+++O2(BO3); Fredrikssonite Mg2(Mn+++,Fe+++)O2(BO3); Azoproite (Mg,Fe++)2(Fe+++,Ti,Mg)BO5; Boracite Mg3B7O13Cl; Karlite (Mg,Al)6(BO3)3(OH,Cl)4; Antigorite (Mg,Fe++)3Si2O5(OH)4; Aspidolite NaMg3AlSi3O10O(OH)2 Sodiumphlogopite NaMg3 [AlSi3O10O](OH)2; Sodicgedrite NaMg6AlSi6Al2O22(OH)2 Pyrope Mg3Al2(SiO4)3 IMA99.005 Na2Mg5(PO4)4.7H2O Chlormagaluminite (Mg,Fe++)4Al2(OH)12(C12,CO3).2(H2O); Koenenite Na4Mg4Cl12.Mg5Al4(OH)22 Bobierrite Mg3(PO4)2.8(H2O); Spadaite MgSiO2(OH)2.(H2O)( ) Nesquehonite Mg(HCO3)(OH).2(H2O); Kieserite MgSO4.(H2O) Sanderite MgSO4.2(H2O) Phlogopite KMg3(Si3Al)O10(F,OH)2 Amesite Mg2Al(SiAl)O5(OH)4 278.68; Orthopinakiolite (Mg,Mn++)2Mn+++BO5 Spinel MgAl2O4 MA99.002 (Mg,Mn++)2(Sb0.5Mn+++0.5)O4 Akimotoite (Mg,Fe)SiO3 Majorite Mg3(Fe,Al,Si)2(SiO4)3 Khmaralite (Mg,A,Fe)16(Al,Si,Be)12O40 1; Pyrocoproite*(Mg(K,Na))2P2O7 Garyansellite (Mg,Fe+++)3(PO4)2(OH,O).1,5(H2O) Glushinskite Mg(C2O4).2(H2O); Tetra-ferriphlogopite KMg3Fe+++Si3O10(OH)2 Knorringite Mg3Cr2(SiO4)3; Sepiolite Mg4Si6O15(OH)2.6(H2O) Dittmarite (NH4)Mg(PO4).(H2O); Pseudosinhalite Mg2Al3B2O9(OH); Magniotriplite (Mg,Fe++,Mn)2(PO4)F Monticellite CaMgSiO4; Rimkorolgite Mg5Ba(PO4)4.8(H2O) Gedrite [ ]Mg5Al2Si6Al2O22(OH)2; Serendibite Ca2(Mg,Al)6(Si,Al,B)6O20 Motukoreaite Na2Mg38Al24(CO3)13(SO4)8(OH)108.56(H2O) Clinochlore (Mg,Fe++)5Al(Si3Al)O10(OH)8 Luneburgite Mg3B2(PO4)2(OH)6.5(H2O) Magnesiocummingtonite (Mg,Fe++)7Si8O22(OH)2 Tremolite [ ]Ca2Mg5Si8O22(OH)2 Chesterite (Mg,Fe++)17Si20O54(OH)6 Pigeonite (Mg,Fe++,Ca)(Mg,Fe++)Si2O6; Pinnoite MgB2O4-3(H2O) Fluororichterite Na(CaNa)Mg5[Si8O22]F2; Hornesite Mg3(AsO4)2.8(H2O) Clinojimthompsonite (Mg,Fe++)5Si6O16(OH)2; Jimthompsonite (Mg,Fe++)5Si6O16(OH)2 Potassicrichterite (K,Na)(CaNa)2Mg5[Si8O22](OH,F)2 Edenite NaCa2Mg5Si7AlO22(OH)2 Potassic-fluororichterite (K,Na)(CaNa)MgS[Si8O22]F2 Fluoro-edenite NaCa2Mg5Si7AlO22(F,OH)2 Stevensite (Ca0.5,Na)0.33(Mg,Fe++)3Si4O10(OH)2-n(H2O) Manganocummingtonite [ ]Mn2Mg5Si8O22(OH)2 Prochlorite*(Mg,Fe++,Al)6Al(Si2.5Al1.5)O10(OH)8 Gerstinannite (Mg,Mn)2ZnSiO4(OH)2 Mcguinnessite (Mg,Cu)2(CO3)(OH)2; Mountkeithite (Mg,Ni)11(Fe+++,Cr)3(SO4,CO3)3.5(O H)24.11(H2O); Biotite K(Mg,Fe+++)3[AlSi3O10(OH,F)2 Newberyite Mg(PO3OH)*3 (H2O) Lansfordite MgCO3.5(H2O) Panasqueiraite CaMg(PO4)(OH,F); Isokite CaMg(PO4)F Donpeacorite (Mn,Mg)MgSi2O6; Krinovite NaMg2CrSi3O10 Dolomite CaMg(CO3)2; Taaffeite Mg3Al8BeO16 Trembathite (Mg,Fe++)3B7O13Cl; Efremovite (NH4)2Mg2(SO4)3 Callaghanite Cu2Mg2(CO3)(OH)6.2(H2O); Kerolite (Mg,Ni)3Si4O10(OH)2.(H2O)Magnesiocoulsonite MgV++++2O4; Eitelite Na2Mg(CO3)2 Tochilinite 6Fe0.9S.5(Mg,Fe++)(OH)2 Welshite Ca2Sb+++++Mg4Fe+++Si4Be2O2O Baricite (Mg,Fe++)3(PO4)2.8(H2O); Magnesiochromite MgCr2O4 Starkeyite MgSO4.4(H2O) Preobrazhenskite Mg3B11O15(OH)9 Calciotalc CaMg2Si4O10(OH)2 Haapalaite 2(Fe,Ni)S.1.6(Mg,Fe++)(OH)2 Uklonskoyite NaMg(SO4)F.2(H2O); Ellenbergerite Mg6TiAl6Si8O28(OH)10 Magnesioferrite MgFe+++2O4 Eckermannite NaNa2(Mg4Al)Si8O22(OH)2 Winchite [ ](CaNa)Mg4(AL,Fe+++)Si8O22(OH)2 Preiswerkite NaMg2Al3Si2O10(OH)2; IMA98.066 CaMg(VO4,AsO4)(OH) Taeniolite KLiMg2Si4O10F2; Tainiolite KLiMg2Si4O10F2 Bischofite MgCl2.6(H2O); Magnesiokatophorite Na(CaNa)Mg4AlSi7AlO22(OH)2 Magnesiohornblende Ca2 [Mg4(Al,Fe+++)]Si7AlO22(OH)2 Warwickite Mg(Ti,Fe+++,Al)(BO3)O Ferriwinchite NaCaMg4Fe+++Si8O22(OH)2 Magnesium-chlorophoenicite (Mg,Mn)3Zn2(AsO4)(OH,O)6 Langbeinite K2Mg2(SO4)3; Magnesio-arfvedsonite NaNa2(Mg4Fe++)Si8O22(OH)2 Paragasite NaCa2(Mg4Al)Si6Al2O22(OH)2 Girvasite NaCa2Mg3(PO4)2[PO2(OH)2](CO3)(OH)2.4(H2O) Eastonite KMg2Al[Al2Si2O10](OH)2; Pentahydrite MgSO4.5(H2O) Hannayite (NH4)2Mg3H4(PO4)4.8(H2O) Cannilloite CaCa2Mg4Al(Si5Al3)O22(OH)2 Fluorocannilloite CaCa2(Mg4Al)Si5Al3O22F2 Saponite (Ca/2,Na)0,3(Mg,Fe++)3(Si,Al)4O10(OH)2.4(H2O) Magnesiohastingsite NaCa2(Mg4Fe+++)Si6Al2O22(OH)2 Diopside CaMgSi2O6 Kaersutite NaCa2(Mg4Ti)Si6Al2O23 (OH)2 Tirodite Mn++2(Mg,Fe++)5 Si8O22(OH)2; Magnesioanthophyllite (Mg,Fe++)7Si8O22(OH)2 Adelite CaMg(AsO4)(OH); Magnesiochloritoid MgAl2SiO5(OH)2 Hauckite (Mg,Mn++)24Zn18Fe+++3(SO4)4(CO3)2(OH)81( ) Tilasite CaMg(AsO4)F Halurgite Mg2[B4O5(OH)4]2.(H2O) Arnhemite*(K,Na)4Mg2(P2O7) 5(H2O); Hexahydrite MgSO4.6(H2O) Loughlinite Na2Mg3Si6O16.8(H2O) Weberite Na2MgAlF7 Ferrosilite (Fe++,Mg)2Si2O6; Hypersthene*(Mg,Fe++)2Si2O6 Wonesite (Na,K)(Mg,Fe,Al)6(Si,Al)8O20(OH,F)4; Magbasite KBa(Al,Sc)(Mg,Fe++)6Si6O20F2 Brassite Mg(AsO3OH).4(H2O) Prismatine ([ ],Fe,Mg)(Mg,Al,Fe)5Al4Si2(Si,Al)2(B,Si,Al)(O,OH,F)22; Mg Nissonite Cu2Mg2(PO4)2(OH)2.5(H2O); Schoenfliesite MgSn++++(OH)6 Struvite (NH4)MgPO4.6(H2O); Surinamite (Mg,Fe++)3Al4BeSi3O16 Phosphorrosslerite Mg(PO3OH).7(H2O); Epsomite MgSO4.7(H2O) Bradleyite Na3Mg(PO4)(CO3) Schaferite NaCa2Mg2(VO4)3 Northupite Na3Mg(CO3)2Cl Kainite MgSO4.KCl.3(H2O) Clinoholmquistite [ ](Li2Mg3Al2)Si8O22(OH)2 Holmquistite [ ](Li2Mg3Al2)Si8O22(OH)2 Karpinskite (Mg,Ni)2Si2O5(OH)2; Nitromagnesite Mg(NO3)2.6(H2O) Tachyhydrite CaMg2Cl6.12(H2O); Glaucophane [ ]Na2(Mg3Al2)Si8O22(OH)2 Tychite Na6Mg2(CO3)4(SO4); Aluminobarroisite CaNaMg3Al2(Si7Al)O22(OH)2 Fedorovskite Ca2(Mg,Mn)2B4O7(OH)6 Nyboite NaNa2(Mg3Al2)Si7AlO22(OH)2; Panethite (Na,Ca,K)2(Mg,Fe++,Mn)2(PO4)2 Ferri-clinoholmquistite [ ]Li2Mg3(Fe3+)2(Si8O22)(OH)2 Johillerite Na(Mg,Zn)3Cu(AsO4)3; Akermanite Ca2MgSi2O7 Aluminomagnesiotaramite NaCaNaMg3Al2[Si6Al2O22](OH)2; Palygorskite (Mg,Al)2Si4O10(OH).4(H2O) Magnesioferrikatophorite Na2Ca(Mg,Fe++)4Fe+++Si7AlO22(OH)2 Roedderite (Na,K)2(Mg,Fe++)5Sil2O30; Dollaseite-(Ce) CaCeMg2AlSi3O11(OH,F)2 Aldzhanite*CaMgB2O4Cl.7(H2O); Barroisite [ ](CaNa)Mg3AlFe+++Si7AlO22(OH)2 Alumino-winchite NaCa(Mg,Fe++)4AlSi8O22(OH)2 Armalcolite (Mg,Fe++)Ti2O5; Carnallite KMgCl3.6(H2O) Inderite MgB3O3O(OH)5.5(H2O); Kurnalcovite MgB3O3(OH)5.5(H2O) Vermiculite (Mg,Fe++,Al)3(Al,Si)4O10(OH)2.4(H2O) Magnesioriebeckite [ ]Na2(Mg3Fe++2)Si8O22(OH)2 Loweite Na12Mg7(SO4)13.15(H2O) Tschermakite [ ]Ca2(Mg3AlFe+++)Si6Al2O22(OH)2; Norsethite BaMg(CO3)2 Magnesiogedrite (Mg,Fe++)5Al2Si6Al2O22(OH)2; Magnesiotaramite Na(CaNa)Mg3ALFe+++[Si6Al2O22](OH)2 Ferric-nyboite NaNa2Mg3Fe+++TiSi8O22(OH)2 Oldhamite (Ca,Mg,Fe,Mn)S Pargasite NaCa2(Mg,Fe++)4Al(Si6Al2)O22(OH)2 Rosslerite Mg(AsO30H). 7(H2O) Potassic-magnesiosadanagaite (K,Na)Ca2 [Mg3(Al,Fe+++)2][Si5Al3O22](OH)2; Souzalite (Mg,Fe++)3(Al,Fe+++)4(PO4)4(OH)6.(H2O) Actinolite Ca2(Mg,Fe++)5Si8O22(OH)2 Hulsite (Fe++,Mg)2(Fe+++, Sn)O2(BO3); Cordierite Mg2Al4SiSO18 Indialite Mg2Al4Si5O18 Ferri-magnesiotaramite NaCaNaMg3Fe+++2[Si6Al2O22](OH)2 Richterite Na(CaNa)(Mg,Fe++)5[Si8O22](OH)2; Baylissite K2Mg(CO3)2.4(H2O) Hogbomite-15R-18R-24R (Mg,Fe++)1.4Ti0.3Al4O8; Kurchatovite Ca(Mg,Mn,Fe++)B2O5 Clinokurchatovite Ca(Mg,Fe++,Mn)B2O5; Magnesiocarpholite MgAl2Si2O6(OH)4 Brianite Na2CaMg(PO4)2 Potassiepargasite (K,Na)Ca2(Mg,Fe++)5Si8O22(OH,F)2 Lazulite MgAl2(PO4)2(OH)2 Yagiite (Na,K)3Mg4(Al,Mg)6(Si,A)24O60 Arakiite (Zn,Mn++)(Mn++,Mg) 12(Fe+++,Al)2(AsO3)(AsO4)2(OH)23 Camgasite CaMg(AsO4)(OH).5(H2O) Gageite (Mn,Mg,Zn)42Si16O54(OH)40; Gageite-2M (Mn,Mg,Zn)42Si16O54(OH)40 Mcgovernite Mn9Mg4Zn2As2Si2017(OH)14 Indigirite Mg2Al2(CO3)4(OH)2.15(H2O) Kellyite (Mn++,Mg,Al)3(Si,Al)2O5(OH)4; Schertelite (NH4)2MgH2(PO4)2.4(H2O) Chlorophoenicite (Mn,Mg)3Zn2(AsO4)(OH,O)6 Merwinite Ca3Mg(SiO4)2; Penikisite BaMg2Al2(PO4)3(OH)3 Blodite Na2Mg(SO4)2.4(H2O); Simferite Li0.5(Mg0.5,Fe+++0.03,Mn+++0.2)2(PO4)3 Blatterite (Mn++,Mg)35Sb3(Mn+++,Fe+++)9(BO3)16O32 Aksaite MgB6O7(OH)6.2(H2O); Hungchaoite MgB4O5(OH)4.7(H2O) Chayesite K(Mg,Fe++)4Fe+++(Si12O30); Chelkarite CaMgB2O4Cl2.7(H2O)( ) Molybdophyllite Pb9Mg9Si9O24(OH)24; Kaliborite KHMg2B12O16(OH)10.4(H2O) Balipholite BaMg2LiAl3 Si4O12(OH,F)8; Magnesiosadanagaite (K,Na)Ca2(Mg,Fe++,Al,Ti)5[(Si,Al)8O22](OH)2; Gaspeite (Ni,Mg,Fe++)CO3 Boussingaultite (NH4)2Mg(SO4)2.6(H2O) Rorisite (Ca,Mg)FCl Ribbeite (Mn++,Mg)5(SiO4)2(OH)2 Bystromite MgSb2O6 Hibbingite (Fe,Mg)2(OH)3Cl Alumino-barroisite CaNa(Mg,Fe++)3Al2[AlSi7O22](OH)2; Manganhumite (Mn,Mg)7(SiO4)3(OH)2 Leonite K2Mg(SO4)2.4(H2O); Overite CaMgAl(PO4)2(OH).4(H2O); Admontite MgB6O10.7(H2O) Whiteite-(CaMnMg) CaMn++Mg2Al2(PO4)4(OH)2.8(H2O); Whiteite-(CaFeMg) Ca(Fe++,Mn++)Mg2Al2(PO4)4(OH)2.8(H2O); Dravite NaMg3Al6(BO3)3Si6O18(OH)4 Whiteite-(MnFeMg) (Mn++,Ca)(Fe++,Mn++)Mg2Al2(PO4)4(OH)2.8(H2O) Mcallisterite Mg2B12O14(OH)12.9(H2O) Liebenbergite (Ni,Mg)2SiO4; Juonniite CaMgSc(PO4)2(OH)-4(H2O) Juanite Ca10Mg4Al2Si11O39.4(H2O); Berzeliite (Ca,Na)3(Mg,Mn)2(AsO4)3 Crossite Na2(Mg,Fe++)3(Al,Fe+++)2Si8O22(OH)2 Tatarskite Ca6Mg2(SO4)2(CO3)2C14(OH)4.7(H2O) Widgiemoolthalite (Ni,Mg)5(CO3)4(OH)2.4-5(H2O) Segelerite CaMgFe+++(PO4)2(OH).4(H2O) Picromerite K2Mg(SO4)2.6(H2O); Spodiophyllite*(Na,K)4(Mg,Fe++)3 (Fe+++,Al)2(Si8O24); Jahnsite-(CaMnMg) CaMnMg2Fe+++2(PO4)4(OH)2.8(H2O) Harkerite Ca24Mg8Al2(SiO4)8(BO3)6(CO3)10.2(H2O) Bayleyite Mg2(UO2)(CO3)3.18(H2O); Hydroboracite CaMgB6O8(OH)6.3(H2O) Botryogen MgFe+++(SO4)2(OH).7(H2O); IMA98.061 Na(LiNa)(Fe+++2Mg2Li)Si8O22(OH)2 Satterlyite (Fe++,Mg)2(PO4)(OH) Talmessite Ca2Mg(AsO4)2.2(H2O) Fuenzalidaite K6(Na,K)4Na6Mg10(SO4)12(IO3)12.12(H2O); IMA99.024 KCrMg(Si4O10)(OH)2 Leakeite NaNa2(Mg2Fe+++2Li)Si8O22(OH)2; Aluminotschermalcite Ca2(Mg,Fe++)3Al2(Si7Al)O22(OH)2; IMA99.050 NaMg3V6(Si6O18)(BO3)3(OH)4 Chromdravite. NaMg3(Cr,Fe+++)6(BO3)3Si6O18(OH)4 Aldermanite Mg5Al12(PO4)8(OH)22.32(H2O)1; Kennedyite Mg(Fe+++)2Ti3O10 Chamosite (Fe++,Mg,Fe++)5Al(Si3Al)O10(OH,O)8; Orthochamosite (Fe++,Mg,Fe+++)5Al(Si3Al)O10(OH,O)8 Mantienneite KMg2Al2Ti(PO4)4(OH)3.15(H2O) Ludlamite (Fe++,Mg,Mn)3(PO4)2.4(H2O); Sakhaite Ca3Mg(BO3)2(CO3).0.36(H2O) Gordonite MgAl2(PO4)2(OH)2.8(H2O) Dorrite Ca2Mg2Fe+++4(Al,Fe+++)4Si2O20 Collinsite Ca2(Mg,Fe++)(PO4)2.2(H2O) Iddingsite*MgO.Fe2O3.3SiO2.4(H2O) Feruvite (Ca,Na)(Fe,Mg,Ti)3(Al,Mg,Fe)6(BO3)3Si6O18(OH)4 Carboborite Ca2Mg(CO3)2B2(OH)8.4(H2O) Magnesioferritaramite Na(CaNa)(Mg,Fe++)3Fe+++2[Si6Al2O22](OH)2; Aegirine-augite*(Ca,Na)(Mg,Fe++,Fe+++)[Si2O6]; Harrisonite Ca(Fe++,Mg)6(PO4)2(SiO4)2 Dannemorite M(Fe++,Mg)5Si8O22(OH)2; Pumpellyite-(Mg) Ca2MgAl2(SiO4)(Si2O7)(OH)2.(H2O) Tosudite Na0,5(Al,Mg)6(Si,Al)8O18(OH)12.5(H2O) IMA98.017 Mg(H2O)6[Sb(OH)6]2; Kanoite (Mn++,Mg)2Si2O6 Zhemchuzhnikovite NaMg(Al,Fe+++)(C2O4)3.8(H2O) Rabbittite Ca3Mg3(UO2)2(CO3)6(OH)4.18(H2O) Clinoferrosilite (Fe++,Mg)2Si2O6 Maghagendorfite NaMgMn(Fe++,Fe+++)2(PO4)3; Inderborite CaMg[B3O3(OH)5]2.6(H2O) Ushkovite MgFe+++2(PO4)2(OH)2.8(H2O) Boldyrevite*NaCaMgAl3F14.4(H2O) Congolite (Fe++,Mg,Mn)3B7O13Cl; Ericaite (Fe++,Mg,Mn)3B7O13Cl Uvite (Ca,Na)(Mg,Fe++)3Al5Mg(BO3)3Si6O18(OH,F)4 Hydrougrandite*(Ca,Mg,Fe++)3(Fe+++,Al)2(SiO4)3-x(OH)4×Svyazhinite MgAl(SO4)2F.14(H2O); Stepanovite NaMgFe+++(C2O4)3.8-9(H2O) Sverigeite NaMnMgSn++++Be2Si3O12(OH); Aluminoceladonite KAl(Mg,Fe++)[ ]Si4O10(OH)2 Borcarite Ca4MgB4O6(OH)6(CO3)2; Vanthoffite Na6Mg(SO4)4 Seelite-2 Mg(UO2)(AsO3)x(AsO4)1-x-7(H2O)(x=0.7); Magnesiofoitite [ ](Mg2Al)Al6(Si6O18)(BO3)3(OH)4 Humberstonite K3Na7Mg2(SO4)6(NO3)2.6(H2O) Wendwilsonite Ca2(Mg,Co)(AsO4)2.2(H2O); Sclarite (Zn,Mg,Mn++)4Zn3(CO3)2(OH)10 Wilcoxite MgAl(SO4)2F.18(H2O) 586.69; Magnesio-axinite Ca2M12BO3Si4O12(OH) Polyhalite K2Ca2Mg(SO4)4.2(H2O); Willemseite (Ni,Mg)3Si4O10(OH)2 Wiluite Ca19(Al,Mg,Fe,Ti)13(B,Al,[ ])5Si18O68(O,OH)10 2,928.82; Aerinite (Ca,Na)4Mg3(Fe+++,Fe++,Al)3 [(Si,Al)O42](OH)6.n(H2O)(n˜11.3); Seelite-1 Mg[(UO2)(AsO3)x(AsO4)1-x]2.7(H2O) Sadanagaite (K,Na)Ca2(Fe++,MgAl,Ti)5[(Si,Al)8O22](OH)2; Magnesiumastrophyllite (Na,K)4Mg2(Fe++,Fe+++,Mn)5Ti2Si8O24(O,OH,F)7 1,254.91; Aristarainite Na2MgB12O20.8(H2O) Usovite Ba2CaMgAl2F14; Donathite (Fe++,Mg)(Cr,Fe+++)2O4 Akrochordite Mn4Mg(AsO4)2(OH)4.4(H2O); Bredigite Ca7Mg(SiO4)4 Maufite (Mg,Ni)Al4Si3O13.4(H2O); Osumilite-(Mg) (K,Na)(Mg,Fe++)2(Al,Fe+++)3(Si,A)12O30; Ferri-annite K(Fe++,Mg)3(Fe+++,Al)Si3O10(OH)2 Hummerite KMgV+++++5O14.8(H2O) Kutnohorite Ca(Mn,Mg,Fe++)(CO3)2; Ankerite Ca(Fe++,Mg,Mn)(CO3)2 Landesite (Mn,Mg)9Fe+++3(PO4)8(OH)3.9(H2O); Triplite (Mn,Fe++,Mg,Ca)2(PO4)(F,OH) Vesuvianite Ca10Mg2Al4(SiO4)5(Si2O7)2(OH)4 Magnesioaubertite (Mg,Cu)Al(SO4)2Cl.14(H2O) Zirklerite (Fe++,Mg)9Al4Cl18(OH)12.14(H2O)( ) 1, Swartzite CaMg(UO2)(CO3)3.12(H2O) Sahamalite-(Ce) (Mg,Fe++)Ce2(CO3)4 Povondraite (Na,K)(Fe+++,Fe++)3(Fe,Mg,Al)6(BO3)3Si6O18(OH)4 Jervisite (Na,Ca,Fe++)(Sc,Mg,Fe++)Si2O6 Falcondoite (Ni,Mg)4Si6O15(OH)2.6(H2O) Manganese-hornesite (Mn,Mg)3(AsO4)2.8(H2O) Ursilite*(Mg,Ca)4[(UO2)4(OH)5/(Si2O5)5.5].13(H2O) Chelyabinskite*(Ca,Mg)3 Si(OH)6(SO4,CO3)2.9(H2O) IMA97.013 Ca8Mg(SiO4)4Cl2 Swinefordite (Li,Ca0.5,Na)0.72(LI,Al,Mg)2.66(Si,Al)4O10(OH,F)2.2(H2O); Chloritoid (Fe++,Mg,Mn)2Al4Si2O10(OH)4 Odanielite Na(Zn,Mg)3H2(AsO4)3; Irhtemite Ca4Mg(AsO3OH)2(AsO4)2.4(H2O) Ferroclinoholmquistite Li2(Fe++,Mg)3Al2Si8O22(OH)2 Nickelhexahydrite (Ni,Mg,Fe++)(SO4).6(H2O) Chessexite (K,Na)4Ca2Mg3Al8(SiO4)2(SO4)10(OH)10.40(H2O) Sklodowskite (H3O)2Mg(UO2)2(SiO4)2.4(H2O) Pickeringite MgAl2(SO4)4.22(H2O); Slavikite NaMg2Fe+++5(SO4)7(OH)6.33(H2O) Howieite Na(Fe++,Mg,Al)12(Si6O17)2(O,OH)10 Ferritschermakite Ca2(Fe++,Mg)3Al2(Si7Al)O22(OH)2 Retzian-(La) (Mn,Mg)2(La,Ce,Nd)(AsO4)(OH)4; Boyleite (Zn,Mg)SO4.4(H2O) Melilite (Ca,Na)2(Al,Mg,Fe++)(Si,Al)2O7; Merrihueite (K,Na)2(Fe++,Mg)5Si12O30 Lannonite HCa4Mg2Al4(SO4)8F9.32(H2O); Ferroferriwinchite CaNa(Fe++,Mg)4Fe+++[Si8O22](OH)2 921.45Sodic-ferri-clinoferroholmquistite Li2(Fe++,Mg)3Fe+++3Si8O22(OH)2; Saleeite Mg(UO2)2(PO4)2.10(H2O) Ferroferritschermakite Ca2(Fe++,Mg)3Fe+++2(Si7Al)O22(OH)2 Picropharmacolite Ca4Mg(AsO3OH)2(AsO4)2.11 (H2O) Ferritaramite Na(CaNa)(Fe++,Mg)3Fe+++2[Si6Al2O22](OH)2 Ferrikatophorite Na2Ca(Fe++,Mg)4Fe+++(Si7Al)O22(OH)2 Metanovacekite Mg(UO2)2(AsO4)2.4-8(H2O) Protoferro-anthophyllite (Fe++,Mn++)2(Fe++,Mg)5(Si4O11)2(OH)2 Protomangano-ferro-anthophyllite (Mn++,Fe++)2(Fe++,Mg)5(Si4O11)2(OH)2 Bederite ([ ],Na)Ca2(Mn++,MgFe++)2(Fe+++,Mg++,Al)2Mn++2(PO4)6.2H2O); Potassic-chlorohastingsite (K,Na)Ca2(Fe++,Mg)4Fe+++[Si6Al2O22](Cl,OH)2; Chvaleticeite (Mn++,Mg)SO4.6(H2O) Cousinite MgU2Mo2O13.6(H2O); Wicksite NaCa2(Fe++,Mn++)4MgFe+++(PO4)6.2(H2O); Quadruphite-VIII Na14CaMgTi4(Si2O7)2(PO4)4O4F2Haggertyite Ba[Fe++6Ti5Mg]O19 Hawthorneite Ba4[Ti3Cr4Fe4Mg]O19; Merrillite-(Ca)*(Ca,[ ])19Mg2(PO4)14 Pellyite Ba2Ca(Fe++,Mg)2Si6O17; Novacekite Mg(UO2)2(AsO4)2.12(H2O) Merrillite-(Na)*Ca18Na2Mg2(PO4)14Merrillite-(Y)*Ca16Y2Mg2(PO4)14 Montgomeryite Ca4MgA14(PO4)6(OH)4.12(H2O) Magnesium-zippeite Mg2(UO2)6(SO4)3(OH)10.16(H2O) Magnesiocopiapite MgFe+++4(SO4)6(OH)2.20(H2O) Teruggite Ca4MgAs2B12O22(OH)12.12(H2O) Manganberzeliite (Ca,Na)3(Mn,Mg)2(AsO4)3 Ferribarroisite CaNa(Fe++,Mg)3Fe+++2[AlSi7O22](OH)2; Ferroferribarroisite CaNa(Fe++,Mg)3Fe+++2 [AlSi7O22](OH)2 Sekaninaite (Fe++,Mg)2Al4Si5O18 Ferrocarpholite (Fe++,Mg)Al2Si2O6(OH)4; Scorzalite (Fe++,Mg)A12(PO4)2(OH)2 Quadruphite-VII Na14CaMgTi4[Si2O7]2(PO4)4O4F2 Cassidyite Ca2(Ni,Mg)(PO4)2.2(H2O) Albrechtschraufite Ca4Mg(UO2)2(CO3)6F2.17(H2O) Nickelblodite Na2(Ni,Mg)(SO4)2.4(H2O) Rivadavite Na6MgB24O40.22(H2O); Kinichilite Mg0.5[Mn++Fe+++(TeO3)3].4.5(H2O) Homilite Ca2(Fe++,Mg)B2Si2O10; Iquiqueite K3Na4Mg(Cr++++++O4)B24O39(OH).12(H2O); Keystoneite Mg0.5[Ni++Fe++(TeO3)3].4.5(H2O); Zincobotryogen (Zn,Mg,Mn)Fe+++(SO4)2(OH).7(H2O) Zemannite Mg0.5[Zn++Fe+++(TeO3)3] 4.5(H2O) Huemulite Na4Mg(V10O28).24(H2O); Nickel-boussingaultite (NH4)2(Ni,Mg)(SO4)2.6(H2O) 39Krasnovite Ba(Al,Mg)(PO4,CO3)(OH)2.(H2O) Coombsite K(Mn++,Fe++,Mg)13(Si,Al)18O42(OH)14 Hogtuvaite (Ca,Na)2(Fe++,Fe+++,Ti,Mg,Mn)6(Si,Be,Al)6O20; Wardsmithite Ca5MgB24O42.30(H2O); Georgeericksenite Na6CaMg(IO3)6(CrO4)2.12(H2O) Erlianite (Fe++,Mg)4(Fe+++,V+++)2[Si6O15](O,OH) Brandtite Ca2(Mn,Mg)(AsO4)2.2(H2O); Stoppaniite (Fe,Al,Mg)4(Na,[ ])2[Be6Si12O36].2(H2O) Roselite Ca2(Co,Mg)(AsO4)2.2(H2O)Roselite-beta Ca2(Co,Mg)(AsO4)2.2(H2O) Philolithite Pb12O6Mn(Mg,Mn)2(Mn,Mg)4(SO4)(CO3)4Cl4(OH)12; Benstonite (Ba,Sr)6(Ca,Mn)6Mg(CO3)13 Ferrokinoshitalite Ba(Fe++,Mg)(Si2Al2)O10(OH,F)IMA98.039 Sr2Fe(Fe,Mg)2Al4(PO4)4(OH)10; Pumpellyite-(Mn++) Ca2(Mn++,Mg)(Al,Mn+++,Fe)2(SiO4)(Si2O7(OH)2.(H2O) Osumilite-(Fe) (K,Na)(Fe++,Mg)2(Al,Fe+++)3(Si,Al)12O30 Zussmanite K(Fe++,Mg,Mn)13[AlSi17O42](OH)14 Stanekite Fe+++(Mn,Fe++,Mg)(PO4)O; Betpakdalite; [Mg(H2O)6]Ca2(H2O)13[Mo++++++8As+++++2Fe+++3O36(OH)].4(H2O); Jacobsite (Mn++,Fe++,Mg)(Fe+++,Mn+++)2O4 IMA97.012 Ca(Al,Fe++,Mg,Mn)2(AsO4)2(OH)2 Faheyite (Mn,Mg)Fe+++2Be2(PO4)4.6(H2O); Manganotychite Na6(Mn++,Fe++,Mg)2(SO4)(CO3)4 Wupatkiite (Co,Mg,Ni)Al2(SO4)4.22(H2O) Szymanskiite Hg+16(Ni,Mg)6(H3O)8(CO3)12.3(H2O); Redingtonite (Fe++,Mg,Ni)(Cr,Al)2(SO4)4.22(H2O) Kulanite Ba(Fe++,Mn,Mg)2Al2(PO4)3(OH)3; Mathiasite (K,Ca,Sr)(Ti,Cr,Fe,Mg)21O38; Lindsleyite (Ba,Sr)(Ti,Cr,Fe,Mg)21O38 Gottardiite Na3Mg3Ca5Al19Si117O272.93(H2O) Andremeyerite BaFe(Fe++,Mn,Mg)Si2O7; Sturtite (Fe3+)(Mn2+,Ca,Mg)Si4O10(OH)3.10(H2O) Vochtenite (Fe++,Mg)Fe+++[(UO2)(PO4)]4(OH).12-13(H2O) Oursinite (Co,Mg)(H3O)2[(UO2)SiO4]2.3(H2O); Kastningite (Mn++,Fe++,Mg)Al2(PO4)2(OH)2.8H2O; Aliettite (Mg,Fe++)3Si4O10(OH)2(Ca,Na)0.2-0.3(Mg,Fe++)3(Si,Al)4O10(OH)2.4(H2O); Alluaudite NaCaFe++(Mn,Fe++,Fe+++,Mg)2(PO4)3 Alushtite (Ca,Mg,K,Na)Al15MgLi(Fe2+)(Fe3+)[Si6AlO2O](OH)10.3(H2O); Amakinite (Fe++,Mg)(OH)2; Anandite (Ba,K)(Fe++,Mg)3(Si,Al,Fe)4O10(O,OH)2 Ardennite (Mn,Ca,Mg)4(Al,Mn,Fe,Mg)6(As,V,P,Si)(O,OH)4(SiO4)2Si3O10(OH); Augite (Ca,Na)(Mg,Fe,Al,Ti)(Si,Al)2O6 Balangeroite (Mg,Fe+++,Fe++,Mn++)42Si16O54(OH)40; Bariumbannisterite*(K,H3O)(Ba,Ca)(Mn++,Fe++,Mg)21(Si,Al)32O80(O,OH)16.4-12(H2O); Berthierine (Fe++,Fe+++,Mg)2-3(Si,Al)2O5(OH)4 Beusite (Mn++,Fe++,Ca,Mg)3(PO4)2 Bjarebyite (Ba,Sr)(Mn++,Fe++,Mg)2Al2(PO4)3(OH)3; Brammallite*(Na,H3O)(Al,Mg,Fe)2(Si,Al)40.10[(OH)2,(H2O)]; Brindleyite (Ni,Mg,Fe++)2Al(SiAl)O5(OH)4 Burangaite (Na,Ca)2(Fe++,Mg)2Al10(PO4)8(OH,O)12.4(H2O) Canavesite Mg2(CO3)(HBO3).5(H2O) Carlosruizite K6(Na,K)4Na6Mg10(Se++++++O4)12(IO3)12.12(H2O) Carlosturanite (Mg,Fe++,Ti)21(Si,Al)12O28(OH)34.(H2O) Caryinite Na(Ca,Pb)(Ca,Mn)(Mn,Mg)2(AsO4)3 Caryopilite (Mn++,Mg,Zn,Fe++)3(Si,As)2O510(OH,Cl)4 Celadonite K(Mg,Fe++)(Fe+++,Al)[Si4O10](OH)2 Chabazite-Ca (Ca,Na2,K2,Sr,Mg)[Al2Si4O12].6(H2O) Chabazite-K (K2,Ca,Na2,Sr,Mg)[Al2Si4O12].6(H2O) Chabazite-Na (Na2,K2,Ca,Sr,Mg)[Al2Si4O12].6(H2O) Chestermanite Mg2(Fe+++,Mg,Al,Sb+++++)BO3O2 Chevkinite-(Ce) (Ce,La,Ca,Na,Th)4(Fe++,Mg2((Ti,Fe+++)3Si4O22; Chladniite Na2Ca(Mg,Fe++)7(PO4)6 Chudobaite (Mg,Zn)5(AsO30H)2(AsO4)2.10(H2O) Cianciulliite Mn++++(Mg,Mn++)2Zn+2(OH)10.2-4(H2O) Clintonite Ca(Mg,Al)3(Al3Si)O10(OH)2 Corrensite (Mg,Fe,Al)9(Si,Al)8O20(OH)10.n(H2O); Cuprospinel (Cu,Mg)Fe+++2O4 DAnsite Na21Mg(SO4)10Cl3; Dickinsonite (K,Ba)(Na,Ca)5(Mn++,Fe++,Mg)14Al(PO4)12(OH,F)2; Dissakisite-(Ce) Ca(Ce,La)(Mg,Fe++)(Al,Fe+++)2Si3O12(OH) Eifelite KNa3Mg4Si12O30 Ekmanite*(Fe++,Mg,Mn,Fe+++)3(Si,Al)4O10(OH)2.2(H2O); Erionite (K2,Na2,Ca,Mg)2[Al4Si14O36].15(H2O) Faujasite (Na2,Ca,Mg)3.5[Al7Si17O48].32(H2O) Faujasite-Ca (Ca,Na2,Mg)3.5[Al7Si17O48].32(H2O) Faujasite-Mg (Mg,Na2,Ca)3.5[Al7Si17O48].32(H2O) Faujasite-Na (Na2,Ca,Mg)3.5[Al7Si17O48].32(H2O) Ferrierite (Na2,K2,Mg,Ca)3-5Mg[Al5-7Si27.5-31O72].18(H2O) Ferrierite-K (K2,Na2,Mg,Ca)3-5Mg[Al5-7Si27.5-31O72].18(H2O) Ferrierite-Mg (Mg,Na2,K2,Ca)3-5Mg[Al5-7Si27.5-31O72].18(H2O) Ferrierite-Na (Na2,K2,Mg,Ca)3-5Mg[Al5-7Si27.5-31O72].18(H2O) Ferro-alluaudite NaCaFe++(Fe++,Mn,Fe+++,Mg)2(PO4)3; Ferrowyllieite (Na,Ca,Mn)(Fe++,Mn)(Fe++,Fe+++,Mg)Al(PO4)3 Filipstadite (Mn,Mg)2Sb+++++Fe+++O8 Franklinphilite K4(Mn++,Mg,Fe+++,Zn)48(Si,Al)72(O,OH)216.16(H2O) Galaxite (Mn,Fe++,Mg)(Al,Fe+++)2O4 Ganophyllite (K,Na)2(Mn,Al,Mg)8(Si,Al)12O29(OH)7.8-9(H2O) Glauconite (K,Na)(FeA++30 ,Al,Mg)2(Si,Al)4O10(OH)2 Gobbinsite Na4(Ca,Mg,K2)Al6Si10O32.12(H2O) Grandidierite (Mg,Fe++)Al3(BO4)(SiO4)O; Griffithite*4(Mg,Fe,Ca)O.(Al,Fe)2O3.5SiO2.7(H2O) Griphite Na4Ca6(Mn,Fe++,Mg)19Li2Al8(PO4)24(F,OH)8 Hagendorfite NaCaMn(Fe++,Fe+++,Mg)2(PO4)3 Hectorite Na0,3(Mg,Li)3Si4O10(F,OH)2; Hematolite (Mn,Mg,Al)15(AsO3)(AsO4)2(OH)23; Hibonite (Ca,Ce)(Al,Ti,Mg)12O19 Hogbomite-4H-5H-6H-15H (Mg,Fe++)1.4Ti0.3Al4O8; Hogbomite-8H (Al,Fe++,Fe+++,Mg,Ti,Zn)11O15(OH); Holdenite (Mn,Mg)6Zn3(AsO4)2(SiO4)(OH)8 Hydrobiotite K(Mg,Fe)6(Si,Al)8O20(OH)4.x(H2O)Illite*(K,H3O)(Al,Mg,Fe)2(Si,Al)4O10[(OH)2,(H2O)]Jarlite Na2(Sr,Na,[ ])14(Mg,[ ])2Al12F64(OH,H2O)4 Jianshuiite (Mg,Mn++)Mn++++3O7.3(H2O) Joesmithite PbCa2(Mg,Fe++,Fe+++)5Si6Be2O22(OH)2 Johninnesite Na2Mn++9(Mg,Mn++)7(OH)8(AsO4)2(Si6O17)2 Johnsomervilleite Na2Ca(Mg,Fe++,Mn)7(PO4)6 Kaluginite*(Mn++,Ca)MgFe+++(PO4)2(OH).4(H2O); Katoptrite (Mn,Mg)13(Al,Fe+++)4Sb+++++2Si2O28 Kinoshitalite (Ba,K)(Mg,Mn,Al)3 Si2Al2O10(OH)2 Konyaite Na2Mg(SO4)2.5(H2O); Kornerupine Mg3-4(Al,Fe+++)5.5-6(SiO4,BO4)5(O,OH)2-3 Kraisslite (Mn++,Mg)24Zn3Fe+++(As+++++O3)2(As+++O4)3(SiO4)6(OH)18Kulkeite (Mg,Fe++,Fe+++)3[(Mg,Fe++,Fe+++)2Al]Si3AlO10(OH)8/(Mg,Fe++)Si4O10(OH) 2 Langbanite (Mn,Ca,Fe,Mg)++4(M,Fe)9Sb+++++[O16(SiO4)2];Latiumite (Ca,K)8(Al,Mg,Fe)(Si,Al) 10O25(SO4) Lawsonbauerite (Mn,Mg)9Zn4(SO4)2(OH)22.8(H2O); Leisingite Cu(Mg,Cu,Fe,Zn)2Te++++++O6.6(H2O) Lennilenapeite K6-7(Mg,Mn,Fe++,Fe+++,Zn)48(Si,Al)72(O,OH)216.16(H2O); Lindqvistite Pb2(Mn++,Mg)Fe+++16O27; Lourenswalsite (K,Ba)2(Ti,Mg,Ca,Fe)4(Si,Al,Fe)6O14(OH)12 Loveringite (Ca,Ce)(Ti,Fe+++,Cr,Mg)21O38 Lunokite (Mn,Ca)(Mg,Fe++,Mn)Al(PO4)2(OH).4(H2O) Magnesioclinoholmquistite Li2(Mg,Fe++)3Al2Si8O22(OH)2; Magnesiodumortierite (Mg,Ti++++, [ ])<1(Al,Mg)2Al4Si3O18-y(OH)yBy=2-3; Magnesioholmquistite Li2(Mg,Fe++)3Al2Si8O22(OH)2 Magnocolumbite (Mg,Fe++,Mn)(Nb,Ta)2O6; Mangangordonite (Mn++,Fe++,Mg)Al2(PO4)2(OH)2.8(H2O) Manganosegelerite (Mn,Ca)(Mn,Fe++,Mg)Fe+++(PO4)2(OH).4(H2O) Mazzite K2CaMg2(Al,Si)36O72.28(H2O) Mendozavilite Na(Ca,Mg)2Fe+++6(PO4)2(P+++++Mo++++++11O39)(OH,Cl)10.33(H2O); Mengxianminite*(Ca,Na)3(Fe++,M++)2Mg2(Sn++++,Zn)5Al8O29 Minnesotaite (Fe++,Mg)3Si4O10(OH)2 Mongshanite*(Mg,Cr,Fe++)2(Ti,Zr)5O12; Montdorite (K,Na)(Fe++,Mn++,Mg)2.5[Si4O10](F,OH)2 Montmorillonite (Na,Ca)0,3(Al,Mg)2Si40O0(OH)2.n(H2O) Mooreite (Mg,Zn,Mn)15(SO4)2(OH)26.8(H2O) Musgravite (Mg,Fe++,Zn)2Al6BeO12; Niahite (NH4)(Mn++,Mg,Ca)PO4 (H2O) Nickenichite Na0,8Ca0,4(Mg,Fe+++,Al)3Cu0,4(AsO4)3 Nigerite-6H (Zn,Mg,Fe++)(Sn,Zn)2(Al,Fe+++)12O22(OH)2 Nimite (Ni,Mg,Fe++)5Al(Si3Al)O10(OH)8 Nordite-(Ce) (Ce,La,Ca)(Sr,Ca)Na2(Na,Mn)(Zn,Mg)Si6O17 Nordite-(La) (La,Ce)(Sr,Ca)Na2(Na,Mn)(Zn,Mg)Si6O17 Odinite (Fe+++,Mg,Al,Fe++,Ti,Mn)2.4(Si1,8Al0,2)O5(OH)4; Okhotskite-(Mg)*Ca8(Mn++,Mg)(Mn+++,Al,Fe+++)(SiO4)(Si2O7)(OH)2.(H2O); Okhotskite-(Mn++)*Ca8(Mn++,Mg)(Mn+++,Al,Fe+++)(SiO4)(Si2O7)(OH)2.(H2O); Omphacite (Ca,Na)(Mg,Fe++,Fe+++,Al)Si2O6Orthochevkinite*(Ce,La,Ca,Na,Th)4(Fe++,Mg2((Ti,Fe+++)3Si4O22 Ottrelite (Mn,Fe++,Mg)2Al4Si2O10(OH)4 Parwelite (Mn,Mg)5Sb(As,Si)2O12 Paulkerrite K(Mg,Mn)2(Fe+++,Al)2Ti(PO4)4(OH)3.15(H2O) Pehrmanite (Fe++,Zn,Mg)2Al6BeO12; Pengzhizhongite-24R (Mg,Zn,Fe+++,Al)4(Sn,Fe+++)2Al10O22(OH)2 Pengzhizhongite-6H (Mg,Zn,Fe+++,Al)4(Sn,Fe+++)2Al10O22(OH)2; Perrierite (Ce,Ca,La,Nd,Th)4(Fe++,Mg)2(Ti,Al,Zr,Fe+++)2Ti2(Si2O7)2O8; Petedunnite Ca(Zn,M++,Fe++,Mg)Si2O6; Plumboferrite Pb2(Mn++,Mg)0.33Fe+++10.67O18.33 Polyphite-VII Na17Ca3Mg(Ti,Mn)4[Si2O7]2(PO4)6O2F6 Polyphite-VIII Na17Ca3Mg(Ti,Mn)4[Si2O7]2(PO4)6O2F6 Qandilite (Mg,Fe++)2(Ti,Fe+++,Al)O4; Qingheiite Na2Na Mg2(Al,Fe+++)2(PO4)6; Ralstonite NaxMgxAl2-x(F,OH)6.(H2O); Rhodonite (Mn++,Fe++,Mg,Ca)SiO3; Rhonite Ca2(Mg,Fe++,Fe+++,Ti)6(Si,Al)6O20 Roscoelite K(V,Al,Mg)2AlSi3O10(OH)2 Rosemaryite (Na,Ca,Mn++)(Mn++,Fe++)(Fe+++,Fe++,Mg)Al(PO4)3; Santafeite (Mn,Fe,Al,Mg)8(Mn,Mn)8(Ca,Sr,Na) 12(VO4,AsO4)16(OH)20.8(H2O); Sarcopside (Fe++,Mn,Mg)3(PO4)2 Shuiskite Ca2(Mg,Al)(Cr,Al)2(SiO4)(Si2O7)(OH)2.(H2O); Sigismundite (Ba,K,Pb)Na3(Ca,Sr)(Fe++,Mg,Mn)14Al(OH)2(PO4)12 Sinhalite MgAlBO4 Smolianinovite (Co,Ni,Mg,Ca)3(Fe+++,Al)2(AsO4)4.11(H2O); Sobolevite Na11(Na,Ca)4(Mg,Mn)Ti++++4(Si4O12)(PO4)4O5F3; Sobotkite (K,Ca0.5)0.33(Mg0.66Al0.33)3(Si3Al)O10(OH)2.1-5(H2O); Stanfieldite Ca4(Mg,Fe++,Mn)5(PO4)6 Staurolite (Fe++,Mg,Zn)2Al9(Si,Al)4O22(OH)2 Stilpnomelane K(Fe++,Mg,Fe+++,Al)8(Si,Al)12(O,OH)27.2(H2O) Strontiowhitloclite Sr7(Mg,Ca)3(PO4)6[PO3(OH)]Sudoite Mg2(Al,Fe+++)3Si3AlO10(OH)8 Synadelphite (Mn,Mg,Ca,Pb)9(As+++O3)(As+++++O4)2(OH)9.2(H2O)( ); Taneyamalite (Na,Ca)(Mn++,Mg)12[(Si,Al)6O17]2(O,OH)10; Taramellite Ba4(Fe+++,Ti,Fe++,Mg,V+++)4(B2Si8O27)O2Clxx=0 to 1; Ternovite (Mg,Ca)Nb4O11-n(H2O)wheren˜10; Thadeuite (Ca,Mn++)(Mg,Fe++,Mn+++)3(PO4)2(OH,F)2; Titantaramellite Ba4(Ti,Fe+++,Fe++,Mg)4(B2Si8O27)O2Cl×X=0TO1,with Ti>Fe; Torreyite (Mg,Mn)9Zn4(SO4)2(OH)22.8(H2O) Valleriite 4(Fe,Cu)S.3(Mg,Al)(OH)2 Volkonskoite Ca0.3(Cr+++,Mg,Fe+++)2(Si,Al)4O10(OH)2.4(H2O) Wadalite Ca6(Al,Si,Mg,Fe)7O16C13 Welinite-III Mn++6(W++++++,Mg)2Si2(O,OH)14; Welinite-VIII Mn++6(W++++++,Mg)2SiO2(O,OH)14 Werdingite (Mg,Fe)2Al12(Al,Fe)2Si4(B,Al)4O37 Wermlandite (Ca,Mg)Mg7(Al,Fe+++)2(SO4)2(OH) 18.12(H2O) Whitlockite Ca9(Mg,Fe++)(PO4)6(PO3OH) Wyllieite (Na,Ca,Mn++)(Mn++,Fe++)(Fe++,Fe+++,Mg)Al(PO4)3 Yakhontovite (Ca,Na,K)0,3(CuFe++Mg)2Si4O10(OH)2.3(H2O) Yimengite K(Cr,Ti,Fe,Mg)12O19;Yoderite (Mg,Al,Fe+++)8Si4(O,OH)20 Yofortierite (Mn,Mg)5Si8O20(OH)2.8-9(H2O) Yuanfuliite (Mg,Fe++)(Fe+++,Al,MgTi,Fe++)(BO3)O Yushkinite V1-xS.n(Mg,Al)(OH)2 Zanazziite (Ca,Mn)2(Mg,Fe)(Mg,Fe++,Mn,Fe+++)4Be4(PO4)6(OH)4.6(H2O); Wollastonite CaSiO3.

Additionally, minerals mined and packaged to meet federal regulations for consumer products including ((Mg,Al)₂Si₄O₁₀(OH)₂), Mg₃Si₄O₁₀(OH)₂) are exemplary.

Additionally, polymeric materials used for ion-binding including derivatised resins of styrene and divinylbenzene, and methacrylate may be used. The derivatives include functionalized polymers having anion binding sites based on quaternary amines, primary and secondary amines, aminopropyl, diethylaminoethyl, and diethylaminopropyl substituents. Derivatives including cation binding sites include polymers functionalized with sulfonic acid, benzenesulfonic acid, propylsulfonic acid, phosphonic acid, and/or carboxylic acid moieties. Natural or synthetic zeolites may also be used or included as ion-binding materials, including, e.g., naturally occurring aluminosilicates such as clinoptilolite and calcium silicates such as wollastonite. Suitable binder materials include any polymeric material capable of aggregating the particulate materials together and maintaining this aggregation under the conditions of use. They are generally included in amounts ranging from about 10 wt % to about 99.9 wt %, more particularly from about 15 wt % to about 50 wt %, based upon the total weight of the purification material.

Suitable polymeric materials include both naturally occurring and synthetic polymers, as well as synthetic modifications of naturally occurring polymers. The polymeric binder materials generally include one or more thermoset, thermoplastic, elastomer, or a combination thereof, depending upon the desired mechanical properties of the resulting purification material.

In general, polymers melting between about 50° C. and about 500° C., more particularly, between about 75° C. and about 350° C., even more particularly between about 80° C. and about 200° C., are suitable polymeric binders for the invention. For instance, polyolefins melting in the range from about 85° C. to about 180° C., polyamides melting in the range from about 200° C. to about 300° C., and fluorinated polymers melting in the range from about 300° C. to about 400° C., can be particularly mentioned as suitable. Examples of types of polymers suitable for use as binders in the invention include, but are not limited to, thermoplastics, polyethylene glycols or derivatives thereof, polyvinyl alcohols, polyvinylacetates, and polylactic acids. Suitable thermoplastics include, but are not limited to, nylons and other polyamides, polyethylenes, including LDPE, LLDPE, HDPE, and polyethylene copolymers with other polyolefins, polyvinylchlorides (both plasticized and unplasticized), fluorocarbon resins, such as polytetrafluoroethylene, polystyrenes, polypropylenes, cellulosic resins, such as cellulose acetate butyrates, acrylic resins, such as polyacrylates and polymethylmethacrylates, thermoplastic blends or grafts such as acrylonitrile-butadiene-styrenes or acrylonitrile-styrenes, polycarbonates, polyvinylacetates, ethylene vinyl acetates, polyvinyl alcohols, polyoxymethylene, polyformaldehyde, polyacetals, polyesters, such as polyethylene terephthalate, polyether ether ketone, and phenol-formaldehyde resins, such as resols and novolacs. Those of skill in the art will recognize that other thermoplastic polymers can be used in the invention in an analogous manner.

Suitable thermoset polymers for use as, or inclusion in, the binder used in the invention include, but are not limited to, polyurethanes, silicones, fluorosilicones, phenolic resins, melamine resins, melamine formaldehyde, and urea formaldehyde. Suitable elasomers for use as or inclusion in, the binder used in the invention include but are not limited to natural and/or synthetic rubbers, like styrene-butadiene rubbers, neoprenes, nitrile rubber, butyl rubber, silicones, polyurethanes, alkylated chlorosulfonated polyethylene, polyolefins, chlorosulfonated polyethylenes, perfluoroelastomers, polychloroprene (neoprene), ethylene-propylene-diene terpolymers, chlorinated polyethylene, VITON® (fluoroelastomer), and ZALAK® (Dupont-Dow elastomer).

Those of skill in the art will realize that some of the thermoplastics listed above can also be thermosets, depending upon the degree of crosslinking, and that some of each may be elastomers, depending upon their mechanical properties, and that the particular categorization used above is for ease of understanding and should not be regarded as limiting or controlling. Naturally occurring and synthetically modified naturally occurring polymers suitable for use in the invention include, but are not limited to, natural and synthetically modified celluloses, such as cotton, collagens, and organic acids. Biodegradable polymers suitable for use in the invention include, but are not limited to, polyethylene glycols, polylactic acids, polyvinylalcohols, co-polylactideglycolides, and the like.

Material binders may also be chosen from those classes of materials which swell through fluid absorption. These materials include crosslinked polymers such as synthetically produced polyacrylic acids, and polyacrylamides and naturally occuring organic polymers such as celluloses. Minerals which swell with fluid absorption include bentonite and derviatives. These swellable materials bind the magnesium containing mineral particulates or fibers through pressure techniques.

In the specific embodiment of a filter material that may be sterilized the magnesium containing mineral originating from a magnesium containing silicate, magnesium oxide, magnesium hydroxide, or magnesium phosphate and GAC or bone char material are present in approximately equal amounts, with the percentage of binder material kept to a minimum. The binder used must be stable to the temperature, pressure, electrochemical, radiative, and chemical conditions presented in the sterilization process, and should be otherwise compatible with the sterilization to method. Examples of binders suitable for sterilization methods involving exposure to high temperatures (such as steam sterilization or autoclaving) include cellulose nitrate, polyethersulfone, nylon, polypropylene, polytetrafluoroethylene (TEFLON®), and mixed cellulose esters. Purification materials prepared with these binders can be autoclaved when the binder polymers are prepared according to known standards. Desirably, the purification material is stable to both steam sterilization or autoclaving and chemical sterilization or contact with oxidative or reductive chemical species, as this combination of sterilizing steps is particularly suitable for efficient and effective regeneration of the purification material. Additionally, sterilization and regenerating of devices incorporating the magnesium containing mineral materials may be conducted by passing solutions of salt, acid, and/or caustic solutions through the filter.

In the embodiment of the invention wherein sterilization is at least in part conducted through the electrochemical generation of oxidative or reductive chemical species, the electrical potential necessary to generate said species can be attained by using the purification material itself as one of the electrodes. For example, the purification material, which contains polymeric binder, can be rendered conductive through the inclusion of a sufficiently high level of conductive particles, such as GAC, carbon black, or metallic particles to render a normally insulative polymeric material conductive. Alternatively, if the desired level of carbon or other particles is not sufficiently high to render an otherwise insulative polymer conductive, an intrinsically conductive polymer may be used as or blended into the binder. Examples of suitable intrinsically conductive polymers include doped polyanilines, polythiophenes, and other known intrinsically conductive polymers. These materials can be incorporated into the binder in sufficient amount to provide a resistance of less than about 1 kΩ, more particularly less than about 300 Ω.

The purification material of the present invention need not be in the form of a block, but may also be formed into a sheet or film. This sheet or film may, in a particular embodiment, be disposed on a woven or nonwoven web of, e.g., a polymer. The polymer used to form the woven or nonwoven web may be any thermoplastic or thermosetting resin typically used to form fabrics. Polyolefins, such as polypropylene and polyethylene are particularly suitable in this regard.

The efficiency of the purification material and the method for using it to reduce microbiological and chemical contaminants and the flow rate of the fluid through the material, are a function of the pore size within the block and the influent fluid pressure. At constant fluid pressure, flow rate is a function of pore size, and the pore size within the block can be regulated by controlling the size of the magnesium mineral and GAC granules. For example, a large granule size provides a less dense, more open purification material which results in a faster flow rate, and small granule size provides a more dense, less open purification material which results in a slower flow rate. A block 17 formed with relatively large magnesium mineral granules will have less surface area and interaction sites than a block formed with smaller granules. Accordingly, the purification material of large granules must be of thicker dimension to achieve equal removal of microbiological contaminants. Because these factors are controllable within the manufacturing process, the purification materials can be customized by altering pore size, block volume, block outer surface area, and geometric shape to meet different application criteria. Average pore size in a particular embodiment is kept to below several microns, and more particularly to below about one micron, to preclude passage of cysts. It should be noted that the pore size described herein does not refer to the pores within the magnesium mineral or other adsorbent or absorbent particles themselves, but rather to the pores formed within the purification material when the particles are aggregated together by the binder.

The method of making the material of the invention, in its most general aspect, involves combining the particulate magnesium containing minerals (and optional additional particulate adsorbent material(s)) with the binder material under conditions of pressure and temperature that allow at least a portion of the binder to be present in liquid form and that allow for compaction of the particulate, and then solidifying the binder around and/or between the particles. The precise nature of the production process will depend to a certain extent upon the nature of the binder material.

For example, if the binder material is supplied in the form of a liquid solution, suspension, or emulsion (e.g., in a volatile solvent), it may be contacted with the particles by dipping or spraying, and the wet particles compressed in a mold. The mold may be optionally heated to evaporate any necessary solvent. The resulting molded material is then dried to form the purification material of the invention.

If, on the other hand, the binder is a polymer resin, it will typically be mixed in pellet form with the particles of the adsorbent material, and the resulting mixture heated and extruded or molded into the desired shape. Examples of suitable particulate/binder extrusion processes and equipment are disclosed in U.S. Pat. Nos. 5,189,092; 5,249,948; and 5,331,037. Other extrusion equipment and processes may also be used. Moreover, the mixture may be heated and injection molded, without the need for any extrusion. Additionally, the binder, a thermoset, may be generated through a crosslinking process that incorporates initiation by chemical processes, electrochemical processes, irradiation and through physical parameters of temperature and pressure variations.

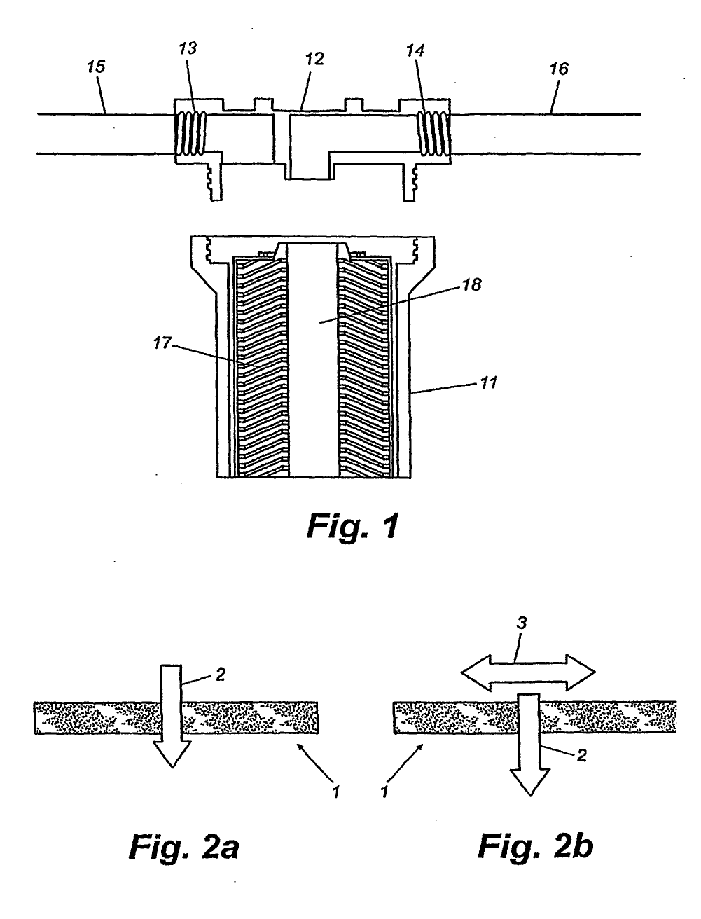

With reference to the drawings, the invention and a mode of practicing it will now be described with regard to one particular embodiment, which meets the EPA requirements for microbiological filters. FIG. 1 illustrates a typical specific embodiment of a filtration apparatus containing the purification material of the invention, which incorporates a rigid porous block filter. A removable housing 11 is mated with a cap 12, the cap 12 having an inflow orifice 13 and an outflow orifice 14. A water supply conduit 15 is joined to the inflow orifice 13 to deliver non-treated water into the device, and a water discharge conduit 16 is joined to the outflow orifice 14 to conduct treated water from the device. Water passes into the housing 11. The pressure of the water flow forces it through the porous block filter member 17, which as shown is formed in the shape of hollow cylinder with an axial bore 18. The treated water then passes into the axial bore 18 which connects to the outflow orifice 14. FIG. 1 is provided as a representative illustration of one possible configuration. It is to be understood that other configurations where water is caused to pass through a porous filter block (which may have different geometrical shapes and/or different flow properties) are contemplated to be within the scope of the invention. The block 17 may be formed by any of a number of known methods, such as by extrusion, compression, molding, sintering, material swelling pressure or other techniques.

FIGS. 2a and 2b shows two embodiments where the purification material of the invention is used in the form of a sheet or film. FIG. 2a shows purification material 1 used in connection with normal flow-through filtration, indicated by arrow 2, which represents the fluid being filtered by passage through the sheet or film 1. FIG. 2b shows purification material 1 used in connection with crossflow filtration. Fluid flowing across the filter is indicated by double-headed arrow 3, while fluid flowing through the purification material 1 is indicated by arrow 2. The cross flow fluid indicated by arrow 3 sweeps across the surface of the purification material 1, decreasing the level of particulate matter deposited thereon.

### EXAMPLE 1

A cylindrical filter block 17 of the shape shown in FIG. 1 may be prepared with a material composition of approximately 42.5% magnesium silicate obtained from R.T. Vanderbilt Company, approximately 42.5% GAC obtained from KX Industries, and approximately 15% thermoplastic binder material selected from one or more of the thermoplastics described above.

The material may then be extruded at a temperature that provides a uniform mixture of magnesium silicate, GAC, and thermoplastic binder. The cylindrical or toroidally shaped block 17 is approximately 9.8 inches in length, with an outer diameter of approximately 2.5 inches and an inner diameter (the bore 18) of approximately 1.25 inches. This shape filter fits into a standard water filtration housing used in the home and industrial settings. The filter material has a resistance of about 300 Ω.

### EXAMPLE 2

The filter prepared in Example 1 may be challenged by exposing it to tap water that is filtered with activated carbon and then seeded with 2.3×10⁸ colony forming units per liter of E. coli bacteria, K. terrigena or similar species and 1.0×10⁷ plaque forming units per liter of MS2. The seeded water is passed through the filter block 17 at a flow rate of approximately 2 liters/minute for 3 minutes, followed by collection of a 500 ml effluent sample. Bacteria and virus are assayed using standard methods. Results indicate significant microbial reduction.

### EXAMPLE 3

The composite prepared in Example 1 may be used to reduce a water soluble chlorine species such as hypochlorous acid in an oxidized state to a chlorine species in a reduced state (choride). Chlorine levels of approximately 2.0 mg/L were reduced to below the detection limits of standard test strip based assays.

As described above, the material of the invention is extremely useful in the area of water purification, particularly the area of drinking water purification. Because of the extremely high efficiency with which the material of the present invention removes microorganisms from water, it meets the EPA guidelines for materials used as microbiological water purifiers. In addition to functioning as a purifier for drinking water, the material of the invention can also be used to purify water used for recreational purposes, such as water used in swimming pools, hot tubs, and spas.

As the result of the ability of the material of the invention to efficiently remove and immobilize microorganisms and other cells from aqueous solutions, it has numerous applications in the pharmaceutical and medical fields. For example, the material of the invention can be used to fractionate blood by separating blood components, e.g., plasma, from blood cells, and to remove microorganisms from other physiological fluids.

The material can also be used in hospital or industrial areas requiring highly purified air having extremely low content of microorganisms, e.g., in intensive care wards, operating theaters, and clean rooms used for the therapy of immunosuppressed patients, or in industrial clean rooms used for manufacturing electronic and semiconductor equipment.

The material of the invention has multiple uses in fermentation applications and cell culture, where it can be used to remove microorganisms from aqueous fluids, such as fermentation broths or process fluids, allowing these fluids to be used more efficiently and recycled, e.g., without cross-contamination of microbial strains. In addition, because the material is so efficient at removing microorganisms and at retaining them once removed, it can be used as an immobilization medium for enzymatic and other processing requiring the use of microorganisms. A seeding solution containing the desired microorganisms is first forced through the material of the invention, and then substrate solutions, e.g., containing proteins or other materials serving as enzymatic substrates, are passed through the seeded material. As these substrate solutions pass through the material, the substrates dissolved or suspended therein come into contact with the immobilized microorganisms, and more importantly, with the enzymes produced by those microorganisms, which can then catalyze reaction of the substrate molecules. The reaction products may then be eluted from the material by washing with another aqueous solution.

The material of the invention has numerous other industrial uses, e.g., filtering water used in cooling systems. Cooling water often passes through towers, ponds, or other process equipment where microorganisms can come into contact with the fluid, obtain nutrients and propagate. Microbial growth in the water is often sufficiently robust that the process equipment becomes clogged or damaged and requires extensive chemical treatment. By removing microorganisms before they are able to propagate substantially, the present invention helps to reduce the health hazard associated with the cooling fluids and the cost and dangers associated with chemical treatment programs.

Similarly, breathable air is often recycled in transportation systems, either to reduce costs (as with commercial airliners) or because a limited supply is available (as with submarines and spacecraft). Efficient removal of microorganisms permits this air to be recycled more safely. In addition, the material of the invention can be used to increase indoor air quality in homes or offices in conjunction with the air circulation and conditioning systems already in use therein.

The purification material of the invention can also be used to purify other types of gases, such as anesthetic gases used in surgery or dentistry (e.g., nitrous oxide), gases used in the carbonated beverage industry (e.g., carbon dioxide), gases used to purge process equipment (e.g., nitrogen, carbon dioxide, argon), and/or to remove particles from surfaces, etc.

In each of these applications, the method of using the material of the invention is relatively simple and should be apparent to those of skill in the filtration art. The fluid or gas to be filtered is simply conducted to one side of a block or sheet of material of the invention, typically disposed in some form of housing, and forced through the material as the result of a pressure drop across the purification material. Purified, filtered fluid or gas is then conducted away from the “clean” side of the filter and further processed or used.

The invention having been thus described by reference to certain of its specific embodiments, it will be apparent to those of skill in the art that many variations and modifications of these embodiments may be made within the spirit of the invention, which are intended to come within the scope of the appended claims and equivalents thereto.

What is claimed is:

1. A purification material for fluids, wherein the material comprises an insoluble magnesium containing mineral and a binder therefore, and is in the form of a porous block or a sheet.

2. The purification material of claim 1, wherein the material is in the form of a porous block.

3. The purification material of claim 2, wherein the porous block is rigid.

4. The purification material of claim 1, wherein the material is in the form of a porous sheet.

5. The purification material of claim 4, wherein the porous sheet is rigid.

6. The purification material of claim 4, wherein the porous sheet is flexible.

7. The purification material of claim 1, wherein at least a portion of said insoluble magnesium containing mineral is in the form of particles, fibers, or a combination thereof

8. The purification material of claim 1, wherein at least a portion of said insoluble magnesium containing mineral is derived from magnesium containing phosphates, silicates, hydroxides, and oxides or combinations thereof.

9. The purification material of claim 1, wherein the binder is a polymer material.

10. The purification material of claim 9, wherein the binder is a polymer melting between about 50° C. and about 500° C.

11. The purification material of claim 10, wherein the polymer is stable under sterilization conditions.

12. The purification material of claim 9, wherein said binder is selected from the group consisting of thermoplastics, polyethylene glycols or a derivative thereof, polyvinyl alcohols, polyvinylacetate, and polylactic acids.

13. The purification material of claim 12, wherein the thermoplastic is selected from the group consisting of nylon, polyethylene, polyvinylchloride, fluorocarbon resins, polystyrene, polypropylene, cellulosic resins, and acrylic resins.

14. The purification material of claim 9, wherein the polymer material comprises a naturally occurring polymer.

15. The purification material of claim 9, wherein the polymer material comprises an electrically conductive polymer.

16. The purification material of claim 14, wherein the naturally occurring polymer is selected from the group consisting of natural and synthetically modified celluloses, collagens, and organic acids.

17. The purification material of claim 9, wherein the polymer material comprises a biodegradable polymer.

18. The purification material of claim 17, wherein the biodegradable polymer is a polyethyleneglycol, a polylactic acid, a polyvinylalcohol, or a co-polylactideglycolide.

19. The purification material of claim 9, wherein said binder is selected from the group consisting of gelling or absorbent polymers.

20. The purification material of claim 19, wherein said binder is selected from the group consisting of superabsorbents.

21. The purification material of claim 9, wherein said binder is selected from the group consisting polylactic acids, polyacrylamides or combinations of the polymers thereof.

22. The composite purification material of claim 9, wherein said superabsorbent comprises a material selected from the group consisting of polyacrylic acids, polyacrylamides, poly-aocohols, polyamines, polyethylene oxides, cellulose, chitins, gelatins. starch, polyvinyl alcohols and polyacrylic acid, polyacrylonitrile, carboxymethyl cellulose, alginic acids, carrageenans isolated from seaweeds, polysaccharides, pectins, xanthans, poly-(diallyldimethylammonium chloride), poly-vinylpyridine, poly-vinylbenzyltrimethylammonium salts, polyvinylacetates, and polylactic acids or a combination thereof.

23. The composite purification material of claim 9, wherein the superabsorbent comprises a material selected from the group consisting of resins obtained by polymerizing acrylic acid and resins obtained by polymerizing acrylamide.

24. The composite purification material of claim 19, wherein the polymer material comprises a naturally occurring polymer, cellulose, alginic acids, carrageenans isolated from seaweeds, polysaccharides, pectins, xanthans, starch, and combinations thereof.

25. The composite purification material of claim 19, wherein the superabsorbent material comprises an ionically charged surface.

26. The composite purification material of claim 25, wherein the superabsorbent material comprises an ionically charged surface ranging from 1-100% of the material surface.

27. The composite purification material of claim 24, wherein the naturally occurring polymer is selected from the group consisting of natural and synthetically modified celluloses, collagens, and organic acids.

28. The composite purification material of claim 19, wherein the superabsorbent material comprises a biodegradable polymer.

29. The composite purification material of claim 19, wherein the superabsorbent material comprises a clay or aluminosilicate material.

30. The composite purification material of claim 29, wherein the superabsorbent material comprises is bentonite.

31. The composite purification material of claim 28, wherein the naturally occurring polymer is a biodegradable polymer selected from the group consisting of a polyethyleneglycol, a polylactic acid, a polyvinylalcohol, a co-polylactideglycolide, cellulose, alginic acids, carrageenans isolated from seaweeds, polysaccharides, pectins, xanthans, starch, and combinations thereof.

32. The purification material of claim 9, wherein the purification material is in the form of a sheet and is disposed on a woven web.

33. The purification material of claim 9, wherein the purification material is in the form of a sheet and is disposed on a nonwoven web.

34. The purification material of claim 1, wherein the binder is present in an amount ranging from about 10 wt % and about 99.9 wt % of the total weight of the purification material.

35. The purification material of claim 1, further comprising one or more additional adsorptive materials different from insoluble magnesium containing minerals.

36. The purification material of claim 35, wherein said additional adsorptive material comprises granulated activated charcoal or a non-magnesium containing apatite or a non-magnesium containing silicate.

37. The purification material of claim 36, wherein said adsorptive material comprises a non-magnesium containing apatite in the form of bone char.

38. The purification material of claim 36, wherein said adsorptive material comprises a non-magnesium containing apatite in the form of an aluminum oxide.

39. The purification material of claim 36, wherein said adsorptive material comprises a non-magnesium containing silicate in the form of calcium silicate.

40. The purification material of claim 36, wherein said magnesium containing mineral and said granulated activated charcoal or apatite are present in approximately equal amounts.

41. The purification material of claim 40, wherein said insoluble magnesium containing mineral and said granulated activated charcoal are each present in amounts of about 42.5 wt %, and said binder is present in an amount of about 15 wt %, based upon the total weight of said purification material.

42. The purification material of claim 41, wherein said insoluble magnesium containing mineral and said non-magnesium containing apatite are each present in amounts of about 42.5 wt %, and said binder is present in an amount of about 15 wt %, based upon the total weight of said purification material.

43. The purification material of claim 35, wherein said additional adsorptive material comprises an ion-binding material selected from the group consisting of synthetic ion exchange resins, zeolites, and phosphate minerals.

44. The purification material of claim 43, wherein the phosphate minerals are members of the phosphate class of minerals.

45. The purification material of claim 43, wherein the phosphate minerals are members of the aluminosilicate group of minerals.

46. The purification material of claim 43, wherein the synthetic ion exchange resins are functionalized styrenes, vinylchlorides, divinyl benzenes, methacrylates, acrylates, and mixtures, copolymers, and blends thereof.

47. The purification material of claim 43, wherein the natural or synthetic zeolites are silicate containing minerals known as clinoptilolite.

48. The purification material of claim 1, further comprising one or more materials that undergo an oxidation or a reduction in the presence of water or aqueous fluid.

49. A device for filtering microbiological contaminants from water or aqueous fluid, comprising:
a housing;
a porous block of the purification material of claim 1.

50. The device according to claim 49, wherein the housing comprises an inlet, an outlet, and a contacting chamber therebetween, and wherein said rigid porous block is disposed within the contacting chamber, such that fluid can flow into the housing from the inlet passes through the porous block and then can flow out of the housing through the outlet.

51. A method for filtering a fluid to remove any microorganisms therefrom, comprising causing the fluid to flow through the purification material of claim 1, thereby obtaining filtered fluid.

52. The method of claim 51, wherein said fluid is water.

53. The method of claim 52, wherein the filtered water is potable.

54. The method of claim 51, wherein said fluid is an aqueous solution.

55. The method of claim 54, wherein said aqueous solution is blood.

56. The method of claim 54, wherein said aqueous solution is a fermentation broth.

57. The method of claim 54, wherein said aqueous solution is a recycled stream in a chemical or biological process.

58. The method of claim 57, wherein the aqueous solution is a recycled stream in a cell culturing process.

59. The method of claim 57, wherein the aqueous solution has been used in a surgical procedure.

60. The method of claim 51, wherein the fluid comprises breathable air.

61. The method of claim 51, wherein the fluid comprises a purge gas.

62. The method of claim 61, wherein the purge gas is selected from the group consisting of O₂, CO₂, N₂, or Ar.

63. The method of claim 51, wherein the fluid is an anesthetic gas.

64. The method of claim 63, wherein the anesthetic gas comprises nitrous oxide.

65. The method of claim 51, further comprising regenerating said purification material by sterilization.

66. The method of claim 65, wherein said sterilization comprises exposing the purification material to elevated temperature, pressure, radiation levels, or chemical oxidants or reductants, or a combination thereof.

67. The method of claim 66, wherein said sterilization comprises autoclaving.

68. The method of claim 67, wherein said sterilization comprises electrochemical treatment.

69. The method of claim 67, wherein said sterilization comprises a combination of chemical oxidation and autoclaving.

70. The method of claim 51, wherein said fluid is a gaseous mixture.

71. The method of claim 70, wherein the filtered gas is air.

72. The method of claim 51, wherein said fluid is a chemically unreactive gas.

73. The method of claim 72, wherein said gas is oxygen, carbon dioxide, nitrogen, argon, or nitrogen oxides.

74. The method of claim 72, wherein said gas is used to pressurize a chamber.

75. The method of claim 72, wherein said gas is used to sparge or purge an aqueous solution for the purpose of increasing the concentration of the sparging gas in the solution.

76. The method of claim 72, wherein said gas is used to sparge or purge an aqueous solution for the purpose of decreasing the concentration of the gases initially present in the solution.

77. The method of claim 72, wherein said gas is used to remove particulate material from surfaces.

78. An immobilization and contacting medium for microorganisms, comprising magnesium containing mineral and a binder therefor, the medium in the form of a rigid, porous block or a sheet.

79. The immobilization and contacting medium of claim 78, further comprising one or more microorganisms disposed within the pores thereof.

80. The regeneration of the material of claim 1 through the use of solutions comprising salt, acid, or caustic.

81. The purification material of claim 36, wherein said adsorptive material comprises wollastonite.
